(19) United States
(12) Patent Application Publication
(10) Pub. No.: US 2026/0161726 A1
(43) Pub. Date: Jun. 11, 2026

(54) SOLVING DISCRETE OPTIMIZATION PROBLEMS

(71) Applicant: Hewlett Packard Enterprise Development LP, Spring, TX (US)

(72) Inventors: Adrien Jean-Pierre Jacques Renaudineau, Le Houx (FR); Fabian Bohm, Stuttgart (DE); Giacomo Pedretti, San Francisco, CA (US); Thomas Van Vaerenbergh, Anderlecht (BE)

(21) Appl. No.: 18/972,276

(22) Filed: Dec. 6, 2024

(51) Int. Cl. G06F 17/11

(52) U.S. Cl. CPC G06F 17/11

(57) ABSTRACT

A computing system may include an optimization preprocessing circuit configured to represent a SAT problem including a plurality of variables and one or more clauses including variables; receive proposed input values for the variables of the SAT problem; output violation indication information for the one or more clauses of the SAT problem according to the proposed input values; and calculate transition cost values for the variables in the SAT problem. The computing system may include leaky integrate-and-fire (LIF) circuitry configured to implement a plurality of LIF neurons, wherein each LIF neuron corresponds to a transition cost value of the transition cost values calculated by the optimization preprocessing circuit; capture the transition cost values in the LIF neurons; evaluate the transition cost values to determine variable selection indicators for determining new proposed input values for the variables of the SAT problem; and output a result based on the variable selection indicators.

This invention was made with government support under FA8650-23-3-7313 awarded by the Defense Advanced Research Projects Agency (DARPA) as part of the Quantum Inspired Classical Computing program. The government may have certain rights in the invention.

### BACKGROUND

In various fields such as mathematics, computer science, engineering, and economics, optimization problems may include problems—sometimes extremely complex problems—of finding an optimum solution from one or more possible solutions. Discrete optimization problems are a particular type of optimization problem and may include problems in which the involved variables have limited possible values (e.g., particular integers, Boolean values, etc.). Boolean satisfiability (SAT) problems may be a type of discrete optimization problem. Solving optimization problems can be a complex and time consuming task for a computing system.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates an example computing system for solving discrete optimization problems, according to some implementations;

FIGS. 2A-2B illustrate example accelerators for solving discrete optimization problems, according to some implementations;

FIG. 3 illustrates an example accelerator for solving discrete optimization problems, according to some implementations;

FIG. 4 illustrates an example accelerator for solving discrete optimization problems, according to some implementations;

FIG. 5 illustrates an example method for solving discrete optimization problems, according to some implementations; and

FIG. 6 illustrates an example method for solving discrete optimization problems, according to some implementations.

### DESCRIPTION

SAT problems are important in computer science and have wide-ranging applications in areas such as artificial intelligence, automated planning, and/or hardware verification. SAT problems may be based on Boolean algebra, which uses binary variables and logical operations. SAT problems may involve determining whether an assignment of Boolean variables exists that satisfies a given logical formula, which may include one or more clauses. The formula may be expressed in terms of logical operators, such as AND, OR, and/or NOT, for example, to represent relations between variables and/or clauses.

The SAT problem may be referred as BSAT (Boolean satisfiability), conjunctive normal form satisfiability (CNF-SAT), propositional satisfiability, the satisfiability problem, and other possible names. In some cases, the SAT problem may also be refered as the propositional Boolean formula problem or the Boolean constraint satisfaction problem. As the complexity and scale of SAT problems grows, efficient hardware accelerators may be appropriate to solve SAT problems relatively quickly and with relatively low energy consumption. A SAT solver may be any suitable combination of hardware, firmware, and software that is used to solve the SAT problem.

Local search methods may provide a heuristic technique that may be used to find a solution to the SAT problem by iteratively improving a given solution. The SAT solver may "flip" a single variable and/or a subset of variables, e.g., change assignment of the variable from true to false or vice versa. The SAT solver may attempt to improve the solution by flipping variables that may lead to satisfying more portions (e.g., clauses) of the formula. While local search methods may be used in any suitable scenario, in some scenarios local search methods may be used when the SAT problem is too complex to be solved using formal logical deduction and/or closed-form solutions or when the search space is too large to be explored exhaustively.

A "novelty" heuristic may be used to improve performance of local search methods. In some examples, novelty heuristics may be used by local search SAT solvers, such as WalkSAT, a greedy local search method (GSAT), simulated annealing, tabu search, variable neighborhood search, iterated local search, and other suitable SAT solvers. As an example, WalkSAT may be a randomized local search algorithm that may iteratively select an unsatisfied clause and flip a variable within that clause. GSAT may flip the variable that may lead to the relatively greatest decrease in the number of unsatisfied clauses. The simulated annealing may be an algorithm that allows for occasional "uphill" moves to escape local optima, with a gradually decreasing probability of accepting worse solutions. The tabu search may use memory structures to avoid revisiting recently explored solutions, potentially helping to escape local optima. The variable neighborhood search may systematically change the neighborhood structure during the search to escape local optima. The iterated local search may alternate between intensification (i.e., local search) and diversification (i.e., perturbation) phases to explore the solution space.

The novelty-based SAT solver may consider the immediate impact of flipping variables. One technique for evaluating the impact of flipping variables is using make/break values. A make value may represent the number of unsatisfied clauses that would become satisfied if a variable is flipped, while a break value may represent the number of satisfied clauses that would become unsatisfied if a variable is flipped.

Novelty-based SAT solving may track when variables were last flipped. Variables that have been flipped recently may be given less priority for flipping again. This may help the SAT solver escape local minima (i.e., a state where flipping any single variable might not improve the solution) and explore a broader range of potential solutions. This approach may allow the SAT solver to navigate the relatively complex solution space efficiently, potentially leading to faster convergence on a satisfying assignment or determination that no such assignment exists.

The novelty heuristic may allow the SAT solver to adapt its search strategy based on history of operations performed by the SAT solver. This can lead to a more efficient traversal of the solution space. Novelty-based SAT solvers may find solutions faster than traditional local search methods. Using the novelty information to make more informed decisions about which variables to flip, the novelty-based SAT solver may balance exploitation and exploration. Exploitation may involve, for example, selecting known appropriate transitions, e.g., based on the make/break values. Exploration may involve, for example, selecting new areas of the solution space, such as by considering variables that have not been flipped recently (based on the last time a flip was made for the variable).

Analog in-memory computing may be used for accelerating computationally-intensive tasks of solving SAT problems. Using the physical properties of memory devices to perform computations directly within the memory array may potentially improve speed and energy efficiency compared to traditional von Neumann architectures. Various memory technologies, such as resistive random-access memory (ReRAM), static random-access memory (SRAM), and/or embedded flash memory (eFlash) may be used for implementing analog in-memory accelerators for solving SAT problems.

Certain implementations of this disclosure relate to using leaky integrate-and-fire (LIF) neurons for novelty-based SAT solver accelerators. Neurons may be used as the foundational building blocks, which may be modeled after the biological neurons in the human brain and which may be used to process and analyze information similarly to how the brain works. In some implementations, the neurons are communicatively coupled together in a network, with each neuron receiving input from other neurons and sending output to other neurons. The connections between neurons are weighted such that some connections are stronger than others, and the strength of the connections may be adjusted over time based on the input that the neurons receive. Each neuron may accumulate input signals over time, "fire" or produce an output when a threshold is reached, and then reset, effectively implementing a time-based memory and decision-making.

In some implementations, the LIF neuron may have a membrane which may be a theoretical boundary separating the neuron internal state from external inputs. The membrane of the LIF neuron may be analogous to the cell membrane of biological neurons. The membrane potential, which may be the electrical potential across the membrane, may determine whether the neuron will fire an action potential or not. When the membrane potential reaches a certain threshold, the neuron may fire the action potential, which may be a relatively brief electrical signal that may travel down the transmitter of electrical impulses and stimulate other neurons.

The LIF neuron may integrate the incoming signals from other neurons and fire a spike when the membrane potential reaches a certain threshold. In some implementations, the membrane potential may be an electrical charge difference across the neuron membrane, which may be analogous to the electrochemical gradient in biological neurons. The integration of signals and firing of spikes may correspond to processing information by the biological neurons through electrical impulses.

In some implementations, the LIF neurons may be implemented as electrical circuits, where the charging process may be implemented by charging a capacitor and the leakage process may be implemented with a resistor short circuiting the capacitor. Although the described implementation shows the LIF neurons being implemented using the capacitor and the resistor, other variations are also possible. For instance, the charging process may be implemented using a voltage source and the leakage process may be implemented using a diode. Additionally, the LIF neurons may be implemented using software or other hardware components.

In some implementations, when the LIF neuron "fires a spike", the LIF neuron may generate a brief, relatively sudden increase in the output signal of the LIF neuron; produce a relatively short-duration pulse or impulse; emit a relatively discrete event or signal to connected neurons; relatively rapidly discharge an accumulated potential of the LIF neuron; and/or transmit a binary "on" signal to downstream components.

The leakage in the LIF model may occur when the membrane potential of the neuron leaks over time, e.g., the membrane potential decreases in the absence of input signals. In some implementations, the leakage property of the LIF neurons may simulate the natural decay of electrical charge in biological neurons, allowing the artificial neuron to "forget" relatively old inputs and maintain sensitivity to relatively new inputs. Certain implementations of the LIF neurons may improve the efficiency and performance of SAT problem-solving, e.g., for edge computing applications.

In some implementations, the SAT problem may be represented in a conjunctive normal form (CNF), where a formula may be a conjunction of clauses (e.g., logical AND operation), and each clause is a disjunction (e.g., logical OR operation) of literals where each literal corresponds to a variable or negation of a variable). Additionally or alternatively, in some implementations, the SAT problem may be represented in a disjunctive normal form (DNF) in which a formula may be a disjunction of clauses and each clause is a conjunction of literals.

A solution to a SAT problem may be an assignment of Boolean values (e.g., true and false or one (1) and zero (0)) to variables that satisfies clauses in the given formula. In some implementations, the solution may be a partial assignment of variables, e.g., some variables in the SAT problem may be assigned either true (1) or false (0), whereas some variables may be left unassigned. This type of solution may be used during the solving process, e.g., as an intermediate step. The solution to the SAT problem may be a complete assignment, e.g., all variables in the SAT problem may be assigned with a value and no variables may be left unassigned. This may represent a full solution to the SAT problem. The solution to the SAT problem may be a clause satisfaction. As an example, each clause in the CNF formula may be evaluated to determine whether the clause is true under a specific assignment of variables.

A solution to the SAT problem may be verified by substituting the assigned values into each clause and finding that some (e.g., for a partial solution) or all (e.g., for a complete solution) clauses are satisfied. Some SAT problems may have multiple valid solutions. In some implementations, finding any one valid solution may be sufficient to solve the SAT problem. The iterative process for finding next solutions may continue to provide more than one solution to the SAT problem.

In certain implementations, the circuitry for implementing the LIF neurons to solve SAT problems may include a content addressable memory (CAM) circuit, a dot product engine (DPE) circuit, and LIF circuitry (which may include LIF neurons and toggle latches). In some implementations, the CAM and DPE may compute the make/break values, which may then be fed as currents to the LIF neurons. The LIF neuron outputs may be coupled to the toggle latches that may capture the current variable assignments.

In some implementations, a representation of a SAT problem may be mapped onto a CAM structure. Each row in the CAM may represent a clause from the CNF formula. The variables (or literals) may be encoded using a ternary system. As an example, zero (0) may represent a positive literal, one (1) may represent a negated literal, and X (“don't care”) may represent the absence of a variable in the clause.

In some implementations, the DPE may be used instead of or in addition to the CAM. In such implementations where the DPE is used instead of or in addition to the CAM, the literals may be represented by crossbar connections (connected/not connected). The output may represent a result of a matrix-vector multiplication of the clause representation matrix and the SAT variable configuration. The output signal of the DPE may be a vector that is proportional to the number of satisfied literals in each individual clause.

In some implementations, the DPE may be used to compute transition cost values, e.g., the make and break values for each variable. In some implementations, the LIF neurons may replace a winner-take-all (WTA) circuit. Each LIF neuron may correspond to a variable in the SAT problem and integrate the make/break values over time.

The LIF neurons may receive input currents proportional to the make/break values. In some implementations, the membrane potential of each LIF neuron increases when the LIF neuron integrates the input signal. When the membrane potential reaches a certain threshold, the LIF neuron may fire and the membrane potential may be reset. The LIF neuron may have a leakage mechanism, causing the potential to decay over time if not stimulated, e.g., by the input current.

When the LIF neuron fires, it may trigger the flipping of its corresponding variable. The flipping of the variable may be implemented using toggle latches coupled to the output of each LIF neuron. As an example, each toggle latch (or a configuration register) may correspond to a certain variable in the SAT problem. In some implementations, the final state of the toggle latches may represent the solution to the SAT problem.

In some implementations, the solution to the SAT problem may be represented as a binary string. As an example, each bit in the binary string may correspond to the value of the variable. As an example, for the SAT problem with variables x1, x2, x3, x4, a solution may be represented as following: x1 equals to one (1), x2 equals to zero (0), x3 equals to one (1), x4 equals to zero (0). In some implementations, the system of the present disclosure may efficiently find such a satisfying assignment of the variables or determine that no such assignment exists (i.e., the problem is unsatisfiable).

In some implementations, a continuous-time version of the present disclosure may allow relatively asynchronous operation, reducing or eliminating use of an external clock signal. This may allow parallelized dynamics and potentially higher throughput, e.g., a higher number of solver iterations per time. In some implementations, the accelerator may operate in discrete time, synchronously updating the internal states of all variables at relatively fixed intervals using sample-and-hold circuits and clocked comparators. The discrete-time version may potentially allow relatively deterministic behavior and relatively straightforward integration with digital control logic while maintaining efficient parallel processing of variables.

The LIF neurons may inherently implement a form of novelty heuristics. As an example, recently flipped variables may have a lower membrane potential due to the reset approach described above. This may make the flipped variables less likely to be flipped again immediately, corresponding to the behavior of traditional novelty heuristics.

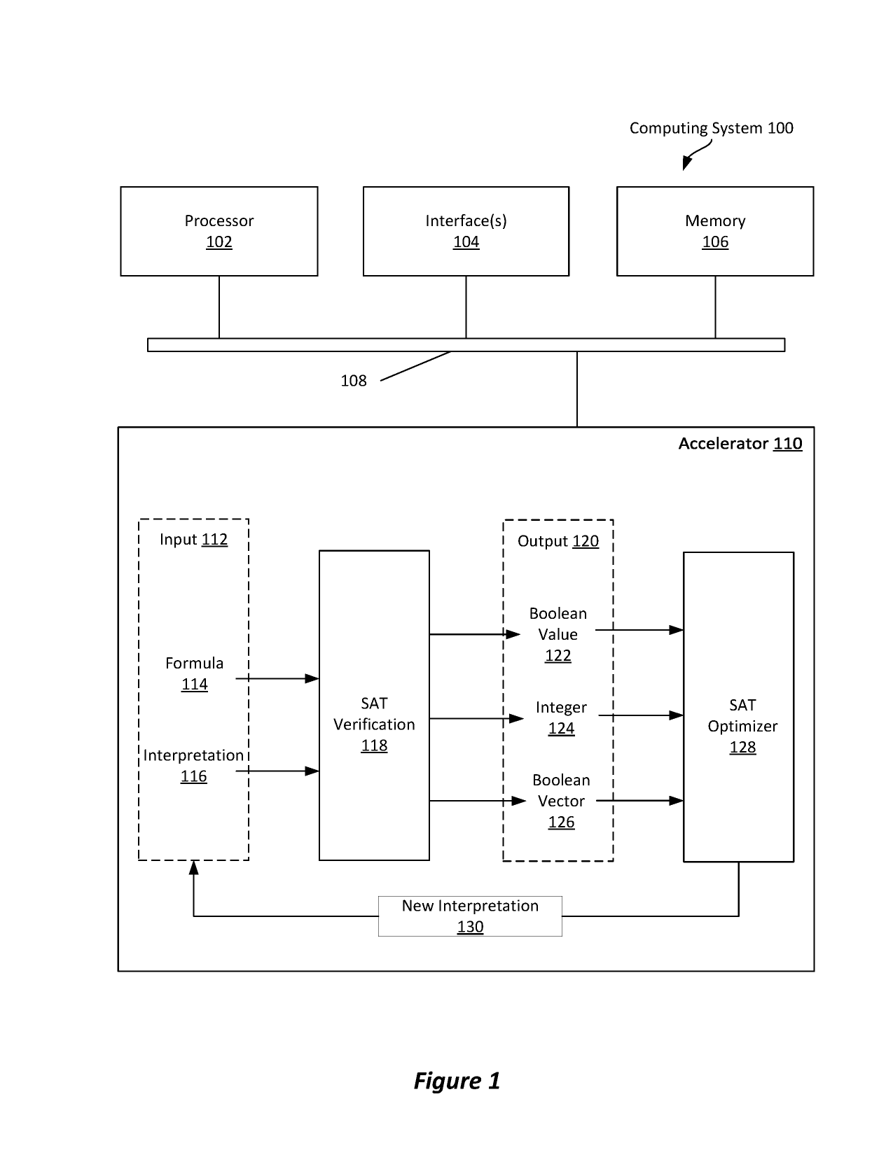

Turning to the figures, FIG. 1 illustrates an example computing system 100 for solving discrete optimization problems, according to some implementations. The computing system 100 may include various components for processing data and solving optimization problems. In some implementations, the computing system 100 includes a processor 102, interface(s) 104, a memory 106, and a bus 108 that facilitates communication between such components. The computing system 100 may also include an accelerator 110, which may be coupled to the bus 108. These components may allow efficient computation and data processing for relatively complex tasks such as SAT problems.

The computing system 100 may be implemented in an electronic device. Examples of electronic devices include servers, desktop computers, laptop computers, mobile devices, gaming systems, and the like. The computing system 100 may be utilized in any data processing scenario, including, for example, stand-alone hardware, mobile applications, or combinations thereof. Further, the computing system 100 may be used in a computing network, such as a public cloud network, a private cloud network, a hybrid cloud network, other forms of networks, or combinations thereof. In one example, the methods provided by the computing system 100 are provided as a service over a network by, for example, a third party. The computing system 100 may be implemented on one or more hardware platforms, in which the modules in the system can be executed on one or more platforms. Such modules can run on various forms of cloud technologies and hybrid cloud technologies or be offered as a Software-as-a-Service that can be implemented on or off a cloud.

In some implementations, the processor 102 retrieves executable code from the memory 106 and executes the executable code. The executable code may, when executed by the processor 102, cause the processor 102 to implement all or any portion of the functionality described herein. The processor 102 may be a microprocessor, an application-specific integrated circuit, a microcontroller, or the like.

In some implementations, the interface(s) 104 allow the processor 102 to interface with various other hardware elements, external and internal to the computing system 100. For example, the interface(s) 104 may include interface(s) to input/output devices, such as, for example, a display device, a mouse, a keyboard, etc. The interface(s) 104 may include interface(s) to an external storage device, or to a number of network devices, such as servers, switches, and routers, client devices, other types of computing devices, and combinations thereof.

The memory 106 may include various types of memory modules, including volatile and nonvolatile memory. For example, the memory 106 may include Random Access Memory (RAM), Read Only Memory (ROM), a Hard Disk Drive (HDD), a Solid State Drive (SSD), or the like. The memory 106 may include a non-transitory computer readable medium that stores instructions for execution by the processor 102. One or more modules within the computing system 100 may be partially or wholly embodied as software and/or hardware for performing any functionality described herein. Different types of memory may be used for different data storage needs. For example, in certain examples the processor 102 may boot from ROM, maintain nonvolatile storage in an HDD, and execute program code stored in RAM.

The interface 104 may allow the computing system 100 to communicate with external devices or networks, thereby allowing input of data for processing and output of results. The processor 102 executes instructions and coordinates the overall operation of the system, including interactions with the accelerator 110.

The accelerator 110 may be a specialized hardware component designed to improve the performance of specific computational tasks, such as solving SAT problems. In some cases, the accelerator 110 may be an analog in-memory accelerator that uses the physical properties of memory devices to perform computations directly within the memory array. This approach may reduce data movement and potentially overcome bottlenecks associated with traditional von Neumann architectures.

The accelerator 110 may include several components for processing SAT problems, including a SAT verification circuit 118 and a SAT optimizer 128. The SAT verification circuit 118 may receive an input 112 containing a formula 114 and an interpretation 116. The formula 114 may be a Boolean expression, such as a CNF or DNF expression, that includes clauses with a certain number of literals (where each literal corresponds to a certain variable or a negated variable). The interpretation 116 may include a set of variables that can be applied to the SAT problem to test if the variables satisfy the clauses.

Upon receiving the input 112, the SAT verification circuit 118 may process the formula 114 and interpretation 116 to determine if the variables satisfy the clauses. In some cases, if the variables do not satisfy each clause, the SAT verification circuit 118 may count the number of violated clauses.

The SAT verification circuit 118 may produce at least one of three types of outputs 120: a Boolean value 122, an integer 124, and/or a Boolean vector 126. The Boolean value 122 may represent whether or not all the clauses are satisfied. The integer 124 may indicate the number of violated clauses based on the current interpretation. The Boolean vector 126 may represent the index of rows where violated clauses are stored.

In some implementations, the SAT verification circuit 118 may generate violation indication information as part of its outputs 120. The violation indication information may be represented in various forms. As an example, the violation indication information may be represented as a Boolean vector 126, where each element corresponds to a clause in the SAT problem, with a value of one (1) indicating a violated clause and zero (0) indicating a satisfied clause.

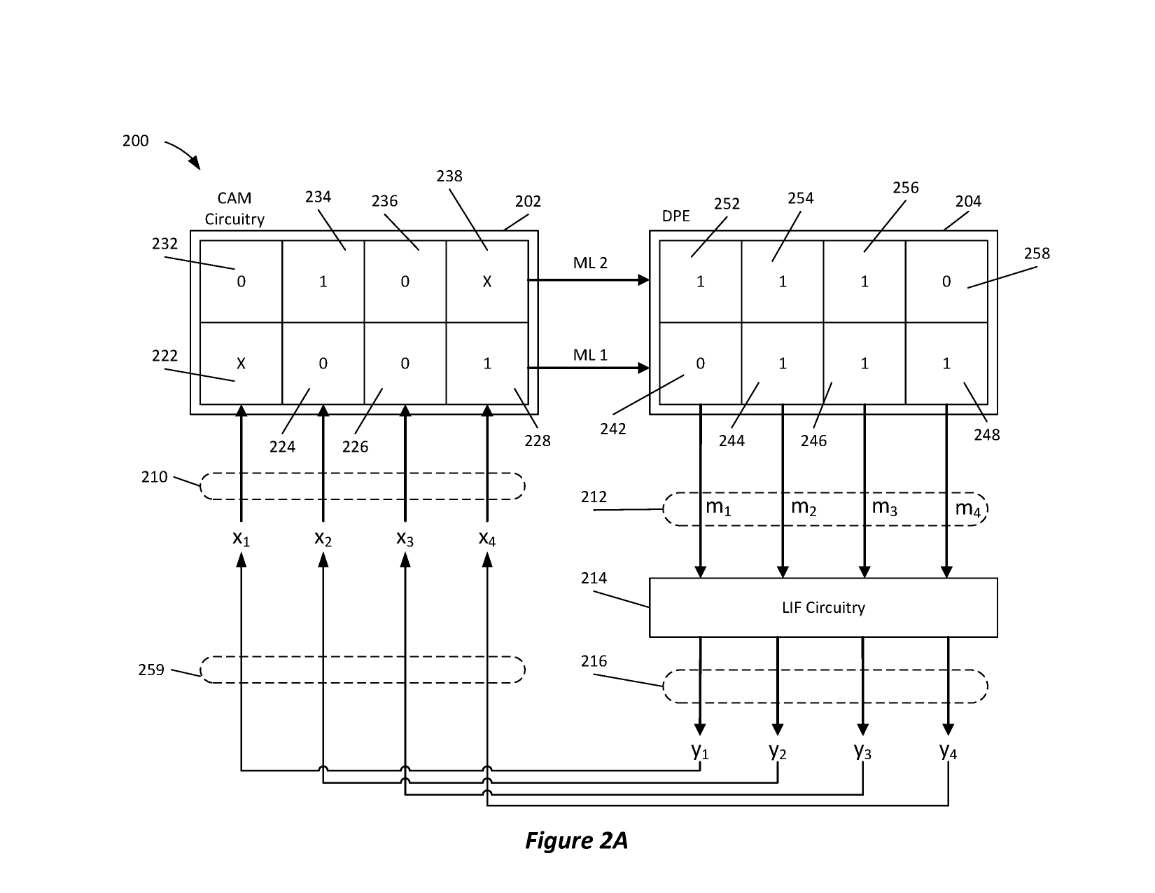

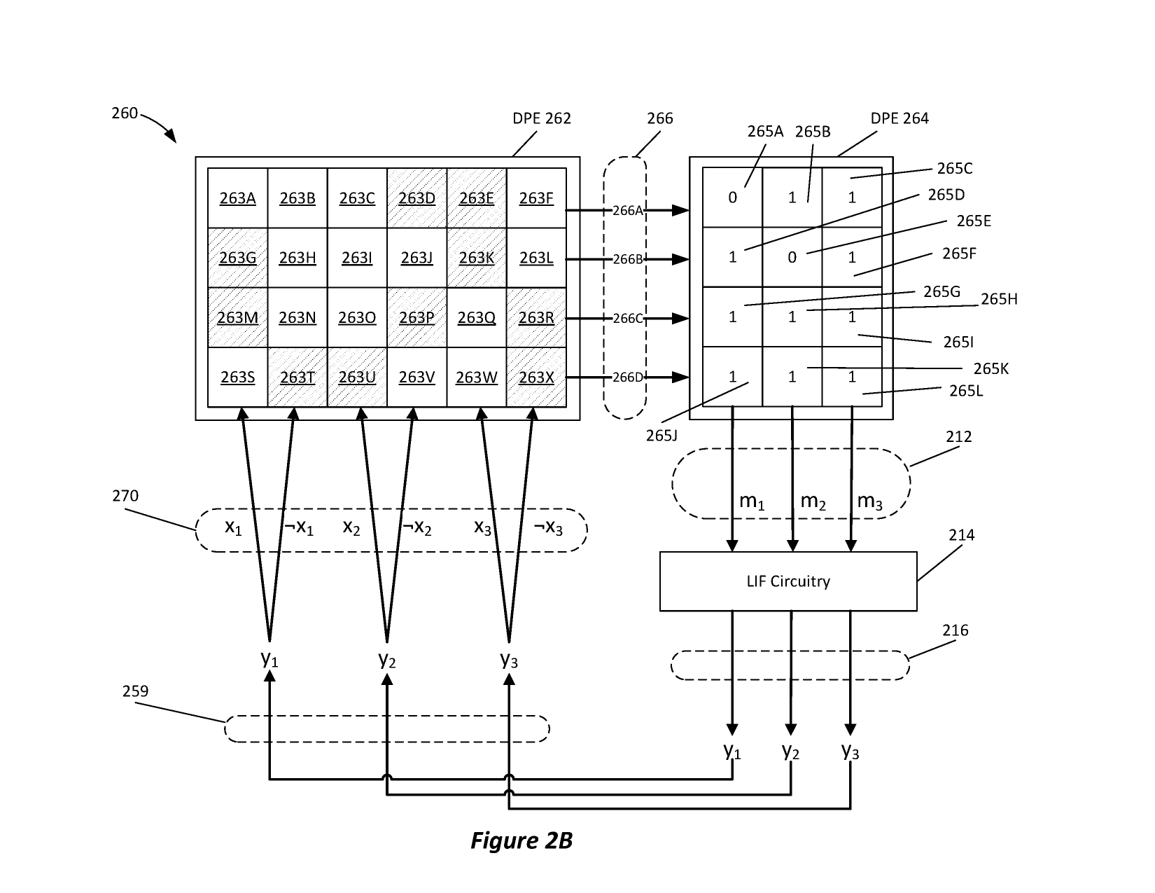

In some implementations, the violation indication information may be represented as an integer 124 representing the total number of violated clauses in the current configuration. In some implementations, the violation indication information may be represented as a set of indices or identifiers corresponding to the specific clauses that are currently violated. Additional details regarding outputs 120 are described below with reference to at least FIGS. 2A-2B.

These outputs 120 from the SAT verification circuit 118 may be passed to the SAT optimizer 128. The SAT optimizer 128 may process the information from the outputs 120 and generate a new interpretation 130. This new interpretation 130 may be configured to satisfy more clauses than the previous input.

The accelerator 110 may operate in an iterative manner, with the new interpretation 130 continuously updating the input 112, specifically the interpretation 116. This updated input may then be re-processed by the SAT verification circuit 118 and the SAT optimizer 128. This cycle may continue until a satisfactory solution is found or other termination criteria are met.

The accelerator 110 may work in conjunction with other components of the computing system 100 to process SAT problems. As an example, the processor 102 may manage the overall operation of the computing system 100 and coordinate the activities of the accelerator 110. The memory 106 may store data and instructions for the processor 102 to execute, including a program code, algorithms, and data structures appropriate for solving SAT problems. The interface 104 may facilitate communication between the computing system 100 and the external devices or networks, allowing for input of SAT problems and output of solutions.

By utilizing the accelerator 110, the computing system 100 may potentially improve efficiency and speed in solving SAT problems. The feedback loop created by the new interpretation 130 may allow for relatively continuous refinement of the solution, potentially leading to faster convergence on satisfactory results, including, potentially, for complex SAT problems.

FIGS. 2A-2B illustrate example accelerators 200 and 260 for solving discrete optimization problems, according to some implementations. The accelerators 200 and 260 may be analog in-memory accelerators. According to some implementations, FIGS. 2A-2B provide more detailed views of how the SAT problem is encoded and processed in the analog in-memory accelerators 200 and 260, implementing the functions of the accelerator 110 described in FIG. 1.

The accelerator 200 illustrated in FIG. 2A may include a content-addressable memory (CAM) circuit 202, a dot product engine (DPE) 204, and leaky integrate-and-fire (LIF) circuitry 214. These components may work together to process and solve complex optimization problems, such as SAT problems. In some implementations, the analog in-memory accelerator 200 operates by encoding SAT problem constraints in the CAM circuit 202, computing intermediate values in the DPE 204, and using the LIF circuitry 214 to generate solutions.

The CAM circuit 202 and the DPE 204 may be coupled via match lines: e.g., match lines ML 1 and ML 2. The match lines ML 1 and ML 2 may transfer information from the CAM circuit 202 to the DPE 204, allowing computation of transition cost values (e.g., make or break values) based on the SAT formula stored in the CAM circuit 202.

In some aspects, the accelerator 200 may receive input variables 210, which may represent the current state of the optimization problem. These input variables 210 may be processed by the CAM circuit 202 and the DPE 204 to generate make values 212. The make values 212 may indicate the potential improvement in the optimization objective if a particular variable is flipped (e.g., changed to an opposite value).

In some implementations, the CAM circuit 202 includes CAM cells, search lines, and match lines ML. The CAM cells 222, 224, 226, 228, 232, 234, 236, 238 can arranged in subsets (e.g., in rows and columns). In some implementations, the CAM circuit 202 includes multiple rows of CAM cells. For example, the CAM circuit 202 may have M rows and K columns. In FIG. 2A, two rows are shown: a first row containing CAM cells 222, 224, 226, and 228, and a second row containing CAM cells 232, 234, 236, and 238. A row of the CAM cells 222, 224, 226, 228, or a row of the CAM cells 232, 234, 236, 238 may be referred to as a CAM row.

The search lines may be arranged along and correspond to the columns of the CAM cells 222 and 232, 224 and 234, 226 and 236, 228 and 238, respectively. The match lines ML may be arranged along and correspond to the rows of the CAM cells 222, 224, 226, 228, and 232, 234, 236, 238, respectively. Each CAM row may store a vector, which may include multiple values (stored in the CAM cells 222, 224, 226, 228, 232, 234, 236, 238 of the CAM rows). As an example, each row of the CAM circuit 202 may be configured to store and compare clause information for the SAT problem.

The CAM cells 222, 224, 226, 228, 232, 234, 236, 238 may be ternary CAM (TCAM) cells. A TCAM cell may store a low value (e.g., a binary zero (0)), a high value (e.g., a binary one (1)), or a wildcard value. Examples of CAM cells include SRAM-based CAM cells, memristor-based CAM cells (such as ReRAM-based CAM cells), and/or other suitable CAM cells.

In some implementations, the DPE 204 may include one or more crossbar arrays that may include programmable elements. In some implementations, the programmable elements may be circuit elements that may have programmable values (e.g., conductances, resistances, and the like). The programmable elements may be non-volatile analog devices, which may be adapted to store one or more bits of data. An example of a programmable element is a memristor (e.g., a ReRAM) cell, which may include a dielectric layer (e.g., an oxide layer) between two conductive (e.g., metal, metal compound, and/or highly doped semiconductor) layers. When the programmable elements are memristors, the crossbar array is a memristor array. Other examples of programmable elements include multi-bit flash memory cells, ReRAM cells, phase change random access memory (PCRAM) cells, magnetoresistive random access memory (MRAM) cells, electrochemical RAM (ECRAM) cells, and/or other suitable programmable elements.

The crossbar array may also include other peripheral circuitries associated with the crossbar array. For example, the crossbar array may include drivers connected to the input electrodes. An address decoder can be used to select an input electrode and activate a driver corresponding to the selected input electrode. The driver for a selected input electrode can drive a corresponding input electrode with different voltages corresponding to a matrix-vector multiplication or the process of setting programmable values within the programmable elements of the crossbar array. Similar driver and decoder circuitry may be included for the output electrodes. Control circuitry may also be used to control application of voltages at the inputs of the crossbar array. Input signals to the input electrodes and the output electrodes can be analog signals. The peripheral circuitry can be fabricated using semiconductor processing techniques in the same integrated structure or semiconductor die as the crossbar array.

In some implementations, the crossbar array can include Z input electrodes and U output electrodes. As described in further detail below, there are at least two operations that occur during operation of the crossbar array. The first operation is to program the programmable elements in the crossbar array so as to map the mathematic values in a Z×U matrix to the programmable elements for crossbar array. The second operation is the dot product or matrix-vector multiplication operation. In this operation, input voltages are applied to the input electrodes and output currents are obtained from the output electrodes, corresponding to the result of multiplying a Z×1 vector with the Z×U matrices. The input voltages are below the threshold of the programming voltage of the programmable elements so the resistance values of the programmable elements in the crossbar array are not changed during the matrix-vector multiplication operation.

As an example, in implementations where the crossbar array uses memristors as programmable elements, the following programming process may be used. The crossbar array may be programmed to store the Z×U matrices by modifying the conductances of the programmable elements. In some implementations, the conductances of the programmable elements are values corresponding to the Z×U matrices. The conductances of the programmable elements may be modified by imposing a voltage across the programmable elements using the input electrodes, the output electrodes, and corresponding voltage drivers. In some implementations, the voltage difference imposed across a programmable element generally determines the resulting conductance of that programmable element. The programming process may be performed row-by-row.

A matrix-vector multiplication may be executed through the crossbar array by applying a set of voltages simultaneously along the input electrodes of the crossbar array and collecting the currents through the output electrodes. The signal generated on an output electrode is weighted by the corresponding conductance of the programmable elements at the crosspoints of the output electrode with the input electrodes, and that weighted summation is reflected in the current at the output electrode. Thus, the relationship between the voltages at the input electrodes and the currents at the output electrodes is represented by a vector-matrix multiplication of the input vector (e.g., the search vector) with the Z×U matrix determined by the conductances of the programmable elements for crossbar array.

The memristor crossbar arrays can be implemented in various architectures, including 1T1M, 2T2M configurations, and self-rectifying crossbar architectures. In some implementations, the 1T1M configuration may have an architecture, where each memristor is coupled to a single transistor, which functions as a switch to control the flow of current through the memristor.

In the 2T2M configuration, each memristor may be coupled to two transistors, which allows for a higher density of memristors to be coupled to a single circuit. The 2T2M architecture may offer high scalability and performance. In the self-rectifying crossbar architecture, the memristors may be arranged in a crossbar pattern, and each memristor may be coupled to two electrodes. The self-rectifying crossbar architecture may allow for bidirectional current flow, which can be used to implement logic functions and other computing operations.

In some implementations, the SAT verification circuit 118 (FIG. 1) may correspond to a combination of the CAM circuit 202 and the DPE 204. The CAM circuit 202 and DPE 204 may perform the function of verifying satisfaction of the SAT clause(s) and computing make/break values. In some implementations, a DPE 262 illustrated in FIG. 2B may be used instead of or in addition to the CAM circuit 202. As an example, the DPE 262 and the DPE 204 may perform the function of verifying satisfaction of the SAT clause(s) and computing make/break values.

In some implementations, input 112 may correspond to input variables 210. As an example, the input variables 210 may represent the current variable assignments being evaluated. In some implementations, the formula 114 may be encoded in the CAM circuit 202. As an example, the CAM rows (each including the CAM cells 222, 224, 226, 228, and the CAM cells 232, 234, 236, 238, respectively) may store the clause information of the SAT formula. As an example, the in-memory CAM may store ternary states (e.g., “0,” “1,” or “don't care” states) for each bit of the stored patterns.

In some implementations, the interpretation 116 may correspond to the input variables 210. As an example, the input variables 210 may represent the current interpretation or assignment of variables.

In some implementations, the violation indication information may be encoded in the match lines ML 1 and ML 2. The match lines ML 1 and ML 2 may indicate which rows (corresponding to clauses) in the CAM circuit 303 are not satisfied by the current input variables 210.

In some implementations, functionality of the Boolean value 122 may be implemented as a logical OR operation on the match lines ML 1 and ML 2 which communicatively couple the CAM circuit 202 and the DPE 204. Although only two match lines (e.g., ML 1 and ML 2) are shown, there may be any number of match lines output of the CAM circuit 202. In some implementations, the number of match lines may be equivalent to the number of SAT clauses stored in the CAM circuit 202. In some implementations, the number of match lines may vary depending on the specific implementation of the CAM circuit 202. The OR operation may determine if all clauses are satisfied (when, e.g., all match lines are low).

The DPE 204 may use the violation indication information received from the CAM circuit 202 to calculate make values 212, which represent the potential improvement in the number of satisfied clauses if a particular variable is flipped.

In some implementations, the outputs 120, specifically the integer 124 and the Boolean vector 126, may correspond to the following. The integer 124 may represent: the total number of violated clauses in the current variable assignment, a count of satisfied clauses, an overall satisfaction score for the current configuration, and/or a measure of how close the current assignment is to satisfying all clauses.

In some implementations, the Boolean vector 126 may correspond to a clause satisfaction vector, where each element represents whether a specific clause is satisfied (e.g., represented by one (1)) or violated (e.g., represented by zero (0)). In some implementations, the Boolean vector 126 may correspond to a variable assignment vector, indicating the current true/false state of each variable in the SAT problem. In some implementations, the Boolean vector 126 may correspond to a change indicator vector, showing which variables were modified in the most recent iteration. In some implementations, the Boolean vector 126 may correspond to a priority vector, indicating a recommendation which clauses or variables should be focused on in the next optimization step.

In some implementations, the SAT optimizer 128 may use the outputs 120 to compute make values 212 and guide the optimization process. The make values 212 may provide information about how many clauses would be satisfied by flipping each variable, which is related to the number of violated clauses.

As an example, the SAT optimizer 128 may analyze the Boolean vector 126 to identify which clauses are violated, and use this information along with the current variable assignment to calculate the make values 212 for each variable. The integer 124 may be used as a relatively quick overall measure of progress, allowing the SAT optimizer 128 to track improvement across iterations without recomputing the total number of satisfied or violated clauses.

The SAT optimizer 128 may include the LIF circuitry 214. In some implementations, the LIF circuitry 214 processes the make values 212 and generates new variable assignments, performing the optimization function. The new interpretation 130 may correspond to the output variables 216, which may represent the updated variable assignments generated by the optimization process.

In some implementations, the LIF circuitry 214 may receive the make values (e.g., the make values 212), break values, or a combination thereof and process them using leaky integrate-and-fire neurons. In some cases, the LIF circuitry 214 may implement novelty-based heuristics to guide the optimization process. The LIF circuitry 214 may generate output variables 216, which may represent updated variable assignments or potential solutions to the optimization problem.

The DPE 204 may function as a transition cost value computation engine, calculating make and break values for variables in the SAT problem. However, the DPE 204 represents just one example of how these computations could be implemented. Other approaches may also be used to calculate transition cost values. For instance, the accelerator 200 may use other analog circuits, digital logic arrays, or specialized processing units to perform these calculations. In some aspects, the computation of transition cost values may be distributed across multiple components or implemented using a hybrid approach combining different computational techniques. The choice of implementation may depend on factors such as power efficiency, speed requirements, and integration with other components.

In some cases, the DPE 204 may include multiple rows and columns of DPE cells, such as DPE cells 242, 244, 246, and 248 in the first row, and DPE cells 252, 254, 256, and 258 in the second row. These DPE cells may store coefficients or weights associated with the optimization problem.

In some aspects, the CAM circuit 202 may be configured to store and compare multiple patterns simultaneously, allowing parallel evaluation of multiple clauses or constraints in the SAT problem. The DPE 204 may use this parallel comparison to efficiently calculate make and break values for multiple variables in a single operation.

Using the match line outputs from the CAM circuit 202, which indicate violated clauses, the DPE 204 can perform a dot product computation between these match line signals and the stored clause-variable membership information. This single matrix-vector multiplication effectively counts how many currently violated clauses would be satisfied (i.e., indicating the make value). This parallel operation allows the DPE 204 to compute make and break values for all variables relatively simultaneously, accelerating the optimization process.

Using the CAM circuit 202, the input vector x1, x2, x3, x4 can be compared to the values representing a SAT clause stored in the CAM. A match line in the CAM for each clause (e.g., the match line ML 1 and the match line ML 2 for the first and second clauses, respectively) determines whether there is a match between search data and stored data in memory cells.

In some implementations, the CAM circuit 202 can be a six transistor, two memristor (6T2M) CAM. The match line of the CAM circuit 202 may indicate a match when an input data line voltage is between an upper and lower bound for an input data line voltage set, at least in part, by the memristors.

In some implementations, a low ML output may indicate that the corresponding clause is satisfied by the current input assignment, while a high match line may indicate an unsatisfied clause. As an example, the match line remains activated when a match is not found (due to inverted nature of encoding), indicating that an input value does not match values and/or value ranges stored in one or more CAM cells 222, 224, 226, 228, 232, 234, 236, 238 of the CAM circuit 202. Operating in parallel, the match line may provide relatively fast content-based searches across multiple cells simultaneously, potentially improving execution of a decision tree implemented, at least in part, using the CAM circuit 202.

In some implementations, the memory cells in the CAM circuit 202 are pre-charged to an initial voltage. When an input voltage is applied, it can be compared against upper and lower bounds set by programmable elements within each cell. A mismatch can occur when the input voltage falls within the lower and upper bounds (due to the inverted nature of encoding values in the CAM circuit 202), causing, at least partially, the cell to maintain its charged state. Otherwise, the CAM cell 222, 224, 226, 228, 232, 234, 236, 238 can discharge, indicating a match (indicating that the clause is satisfied). If any CAM cell 222, 224, 226, 228, 232, 234, 236, 238 in the row does not match, it may pull the match line for that specific row high (or remain high), indicating a mismatch for that clause.

The CAM circuit 202 operation can be configured through various features. It can implement "don't care" states, where only one bound (upper or lower) is checked, or an "always match" condition when both bounds are set to the "don't care" values. The CAM circuit 202 can be configured to operate in a clocked mode, where the match line state is evaluated after a specific time interval. The flexibility in configuration of the CAM circuit 202, combined with the analog matching process, can allow the CAM circuit 202 to perform decision-making tasks efficiently. In some implementations, the CAM circuit 202 allows the accelerator 200 to execute machine learning algorithms with the reduced power consumption and latency compared to the traditional digital implementations.

As an example, in some implementations, zero (0) may represent a positive literal, one (1) may represent a negated literal, and X (“don't care”) may represent the absence of a variable in the clause. However, the accelerator 200 may have various other encoding techniques for representing literals and/or clauses. In some aspects, the representation may be configurable, allowing for different mappings between binary values and literal states. For instance, the accelerator 200 may allow inverting the representation such that one (1) represents a positive literal and zero (0) represents a negated literal. Additionally, in certain implementations, multi-valued logic may be used to represent more complex clause structures or to improve storage efficiency.

In some implementations, the CAM circuit 202 encodes each clause of the SAT problem in a row. In some implementations, the CAM circuit 202 encodes each clause of the SAT problem in a row, but in an inverted manner. In some implementations, the CAM circuit 202 receives input variables 210 (x1, x2, x3, x4) at each column, which represent the current variable assignment being evaluated.

In some implementations, the number of variables described in the SAT problem may be dependent on the specific problem being addressed. While the input vector described herein includes four variables (x1, x2, x3, and x4), other SAT problems may have a different number of variables. In some implementations, the number of variables required to describe the SAT problem may depend on the complexity of the problem and the specific constraints and/or conditions involved.

As an example, the CAM circuit 202 may encode the CNF formula, e.g., 𝑓 = (𝑥1 ∨ ¬𝑥2 ∨ 𝑥3) ∧ (𝑥2 ∨ 𝑥3 ∨ ¬𝑥4), in the following manner. In some implementations, the first row of the CAM circuit 202 may represent the second clause (𝑥2 ∨ 𝑥3 ∨ ¬𝑥4), e.g., the CAM cell 222 may be encoded with value “X” (i.e., “don't care”); the CAM cells 224 and 226 may be encoded with value zero (0); and the CAM cell 228 is encoded with value of one (1). In this implementation, zero (0) may represent a non-negated variable, one (1) may represent a negated variable, and “X” may represent a “don't care” condition where the variable does not appear in the clause.

In some implementations, the second row of the CAM circuit 202 represents the first clause (𝑥1 ∨ ¬𝑥2 ∨ 𝑥3): e.g., the CAM cell 232 may be encoded with value of zero (0); the CAM cell 234 is encoded with value of one (1); e.g., the CAM cell 236 may be encoded with value zero (0); and the CAM cell 238 may be encoded with value “X” (i.e., “don't care”).

In some implementations, for the first clause (x1 ∨ ¬x2 ∨ x3), the encoding of matching or mismatching in a CAM row may be as follows: e.g., for x1, a value of zero (0) may be stored to match when x1 is true; e.g., for x2, one (1) may be stored to match when x2 is “false” (due to the negation of variable x2); e.g., for x3, zero (0) is stored to match when x3 is “true”; for x4, value “X” (e.g., “don't care”) is stored since x4 is not present in this clause.

When input variables x1, x2, x3, x4 are applied, each x1, x2, x3, x4 is converted to a voltage level: for example, to a high voltage for “true” and a low voltage for “false.” These voltages may be applied to the search lines (e.g., column-wise) corresponding to each variable x1, x2, x3, x4. The comparison in each cell (e.g., the CAM cell 222, 224, 226, 228) may be performed according to the following logic.

If the cell (e.g., the CAM cell 224) stores one (1), then the literal (e.g., the negated variable ¬x2) matches if the input voltage is high (“false”). If the cells (e.g., the cells 222 and 226) store a zero (0), then the variables (e.g., x1 and x3) match if the input voltage is low (“true”). If the cell (e.g., the cell 228) stores an “X,” that cell always matches regardless of input voltage.

For the match line ML of a row to discharge to low (indicating a satisfied clause), it may be appropriate for at least one cell in the row to not match its input. This condition may correspond to at least one literal in the clause being true. If all cells in a row match, then the match line ML for that row remains high (due to inverted nature of encoding information into the CAM circuit 202). This condition indicates an unsatisfied clause.

In some implementations, the CAM circuit 202 may relatively simultaneously evaluate all clauses of the SAT problem for a given assignment of variables x1, x2, x3, x4. The state of the match lines, e.g., match lines ML 1 and ML 2, may directly indicate which clauses are satisfied or unsatisfied by the current variable assignment. The inverted encoding allows the CAM circuit 202 to directly identify violated clauses. In some implementations, the high match line may indicate a violated clause, while a low match line may indicate a satisfied clause. This approach may allow a relatively streamlined identification of unsatisfied clauses and subsequent computation of make values 212.

In some implementations, the DPE 204 encodes the variable participation in each clause. As an example, the first row of the DPE 204 may correspond to the clause (𝑥2 ∨ 𝑥3 ∨ ¬𝑥4). In some implementations, the DPE cell 242 may be encoded with a value of zero (0) because x1 variable is not present in this clause. Because variables x2, x3, and x4 are present in the clause, the DPE cell 244 may be encoded with a value of one (1); the DPE cell 246 is encoded with a value of one (1); and the DPE cell 248 may be encoded with a value of one (1).

In some implementations, the second row of the DPE 204 may correspond to the clause (𝑥1 ∨ ¬𝑥2 ∨ 𝑥3). Because variables x2, x3, and x4 are present in the clause, the DPE cell 252 may be encoded with a value of one (1); the DPE cell 254 may be encoded with a value of one (1); and the DPE cell 256 may be encoded with a value of one (1). Because x1 variable is not present in this clause, the DPE cell 258 may be encoded with a value of zero (0).

In operation, the accelerator 200 may work iteratively. The input variables 210 may be applied to the CAM circuit 202, which evaluates clause satisfaction. The DPE 204 processes the information received from the CAM circuit 202 and generates make values 212 (m1, m2, m3, m4) based on the CAM circuit 202 output. These make values 212 represent the potential improvement in the optimization objective if a particular variable is flipped or changed.

In some implementations, an accelerator 260 illustrated in FIG. 2B for evaluating clauses in the SAT problem may represent in the following CNF formula f, which may include, e.g., four clauses represented by the following equation f = (¬x₂ ∨ x₃) ∧ (x₁ ∨ x₃) ∧ (x₁ ∨ ¬x₂ ∨ ¬x₃) ∧ (¬x₁ ∨ x₂ ∨ ¬x₃).

The accelerator 260 may include a DPE 262 configured to evaluate which clauses are violated based on the current variable assignments. The DPE 262 may include DPE cells 263 (e.g., cells 263A through 263X) arranged in rows and columns. Each row of the DPE 262 may correspond to a clause in the CNF formula, while the columns may represent the variables and their negations.

In the DPE 262, a positive literal (e.g., x₁) may be encoded as one (1) in the corresponding DPE cells 263 along the columns with non-negated variable inputs (e.g., cells 263G and 263M). A negated literal (e.g., ¬x₁) may be encoded as one (1) in the corresponding DPE cells 263 along the columns with negated variable inputs (e.g., a cell 263T).

This configuration of the DPE cells 263 allows the system to efficiently represent and process the logical structure of the SAT problem. When a literal is absent from a clause, setting the corresponding DPE cell 263 to not conduct current effectively removes that variable from consideration for that particular clause. This approach allows the DPE 262 to focus only on the relevant variables for each clause, potentially reducing power consumption and improving processing efficiency.

The non-conducting state of these DPE cells 263 may be achieved through various means, depending on the specific implementation of the analog in-memory accelerator. For instance, in the ReRAM based DPE, this may involve setting the cell to a high-resistance state. In the SRAM based implementation, disconnecting the appropriate cell from the current path or setting the cell to a state that prevents current flow may be used to not conduct current through the particular cell.

By selectively allowing or not allowing current flow through specific DPE cells 263, the accelerator 260 may create a physical representation of the logical structure of the SAT problem. This analog encoding allows for parallel evaluation of multiple clauses, as the current flowing through each row of the DPE 262 may correspond to the satisfaction level of the respective clause. The resulting output signals 266 may then be used to determine which clauses are violated or satisfied, guiding the optimization process in subsequent steps.

In some implementations, the DPE 262 may receive input variables 270, which may represent the current assignments of variables x₁, x₂, and x₃, as well as their negations. The input variables 270 may be processed by the DPE cells 263 to evaluate the satisfaction of each clause of the SAT problem.

The output signals 266 of the DPE 262 may indicate the number of satisfied literals in each corresponding SAT clause. For example, signal 266A may correspond to the first clause (¬x₂ ∨ x₃), signal 266B to the second clause (x₁ ∨ x₃), signal 266C to the third clause (x₁ ∨ ¬x₂ ∨ ¬x₃), and signal 266D to the fourth clause (¬x₁ ∨ x₂ ∨ ¬x₃).

In some cases, the accelerator 260 may process the output signals 266 using appropriate logic circuits to generate a vector that indicates the location of violated clauses. For instance, when a clause is violated, the corresponding DPE output may be zero.

For example, using the following variable assignments: x₁ = 0, ¬x₁ = 1; x₂ = 1, ¬x₂ = 0; x₃ = 1, ¬x₃ = 0 in CNF f = (¬x₂ ∨ x₃) ∧ (x₁ ∨ x₃) ∧ (x₁ ∨ ¬x₂∨ ¬x₃) ∧ (¬x₁ ∨ x₂ ∨ ¬x₃), the DPE 262 may output the following output signals 266: since the first clause (¬x₂ ∨ x₃) is satisfied by x₃ = 1, so the output signal 266A may be one (1); the second clause (x₁ ∨ x₃) is satisfied by x₃ = 1, so the output signal 266B may be one (1); the third clause (x₁ ∨ ¬x₂ ∨ ¬x₃) is not satisfied by any variable assignment, so the output signal 266C may be zero (0); the fourth clause (¬x₁ ∨ x₂ ∨ ¬x₃) is satisfied by both ¬x₁ = 1 and x₂ = 1, so the output signal 266D may be two (2).

In some implementations, the DPE 264 encodes the variable participation in each clause. As an example, the first row of the DPE 264 may correspond to the clause (¬x₂ ∨ x₃). In some implementations, the DPE cell 265A may be encoded with a value of zero (0) because x1 variable is not present in this clause. Because variables x2 and x3 are present in the clause, each of the DPE cells 265B and 265C may be encoded with a value of one (1).

In some implementations, the second row of the DPE 264 may correspond to the clause (x₁ ∨ x₃). Because variables x1 and x3 are present in the clause, the DPE cell 265D may be encoded with a value of one (1) and the DPE cell 265F may be encoded with a value of one (1). Because x2 variable is not present in this clause, the DPE cell 265E may be encoded with a value of zero (0).

In some implementations, the third row of the DPE 264 may correspond to the clause x₁ ∨ ¬x₂ ∨ ¬x₃). Because all variables x1, x2, and x3 are present in the clause, each of the DPE cells 265G, 265H, and 265I may be encoded with a value of one (1).

In some implementations, the fourth row of the DPE 264 may correspond to the clause (¬x₁ ∨ x₂ ∨ ¬x₃). Because all variables x1, x2, and x3 are present in the clause, each of the DPE cells 265J, 265K, and 265L may be encoded with a value of one (1).

In operation, the accelerator 260 may work iteratively. The input variables 270 may be applied to the DPE 262, which evaluates clause satisfaction. The DPE 264 processes the information received from the DPE 262 and generates make values 212 (m1, m2, m3) based on the output signals 266 received from the DPE 262. These make values 212 represent the potential improvement in the optimization objective if a particular variable is flipped or changed.

The make values 212 are then fed into the LIF circuitry 214. In some implementations, the LIF circuitry 214 may receive break values and/or the difference of make and break values as input. The LIF circuitry 214 processes these inputs using leaky integrate-and-fire neurons to implement novelty-based heuristics for solving the SAT problem. The LIF circuitry 214 produces output variables 216 (e.g., y1, y2, y3, and/or y4), which represent updated variable assignments or potential solutions to the optimization problem. These output variables 216 may then be fed back into the CAM circuit 202 as new input variables 210 for the next iteration, continuing until a satisfactory solution is found or other termination criteria are met.

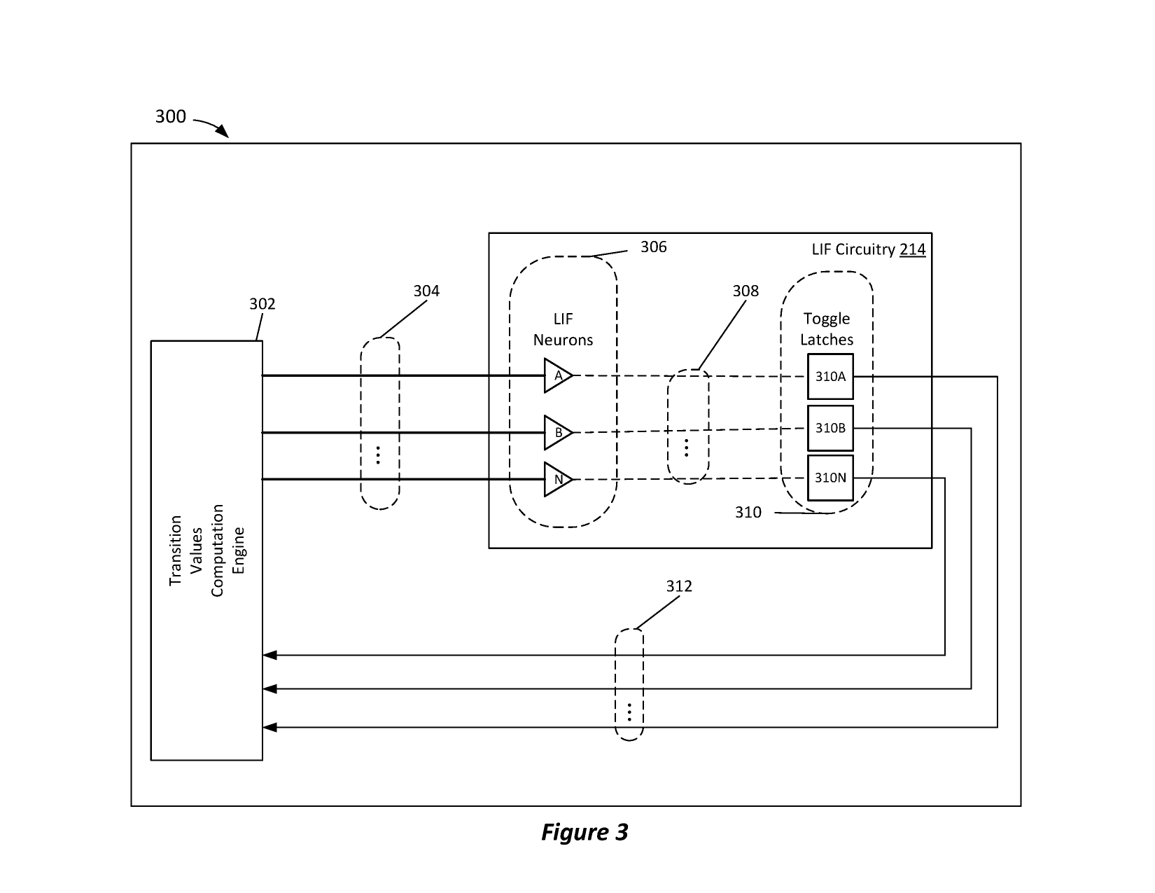

The LIF circuitry 214 implements novelty-based heuristics using the dynamics of LIF neurons (such as LIF neurons 306 in FIG. 3). The LIF neurons of the LIF circuitry 214 may be implemented as analog circuit elements. The membrane potentials of the LIF neurons may allow efficient association with novelty values for variables without requiring additional digital circuitry or memory.

The continuous-time operation of the LIF neurons may allow for asynchronous updates and parallelized dynamics, potentially leading to faster convergence. This approach may offer advantages such as efficient parallel processing of multiple variable interactions and the ability to naturally implement stochastic optimization processes, which may be beneficial for exploring complex solution spaces.

A feedback loop may be implemented through feedback signals 259, allowing the accelerator 200 to iteratively refine its solutions based on previous computations. This feedback mechanism may improve the convergence rate and solution quality for complex SAT problems. The toggle latches, which may be coupled to LIF neurons in the LIF circuitry 214, may output the feedback signals 259. In some implementations, the current state of the variables being optimized may be captured by a memory component (which may be coupled to or included in the toggle latches) that may be efficiently updated based on the output of the LIF neurons.

The accelerator 200 may be compatible with various memory technologies, including ReRAM, SRAM, and/or eFlash. This flexibility may allow for integration with existing hardware platforms and allow scalable designs that can address a wide range of problem sizes and complexities.

The CAM circuit 202 may store and compare multiple patterns simultaneously, allowing for parallel evaluation of multiple clauses or constraints in a SAT problem. The DPE 204 may use this parallel comparison to efficiently calculate make and break values for multiple variables in a single operation. Because the CAM circuit 202 and the DPE 204 may encode the SAT problem constraints and efficiently compute transition cost values, the accelerator 200 may allow parallel evaluation of multiple clauses or variables, accelerating the optimization process.

The ability of the accelerator 200 to use intrinsic circuit noise as a source of randomness may eliminate the need for dedicated pseudo-random number generators, potentially simplifying the hardware design and reducing power consumption. This intrinsic noise may be utilized in the LIF neurons in the LIF circuitry 214 or the WTA circuit to introduce stochasticity in the optimization process. In some implementations, the intrinsic circuit noise may be a clock jitter.

The flexibility of the accelerator 200 to handle different types of optimization problems, including SAT and other discrete optimization problems, may make it suitable for a wide range of applications. The ability to dynamically adjust LIF neuron parameters, such as threshold voltage or leak rate, may allow for the implementation of annealing schedules, potentially improving the ability of the accelerator 200 to find global optima in complex solution spaces.

FIG. 3 illustrates an example accelerator 300 for solving discrete optimization problems, according to some implementations. The accelerator 300 may be an analog in-memory accelerator. The accelerator 300 may include a transition cost values computation engine 302 and LIF circuitry 214. In some implementations, the LIF circuitry 214 may include a plurality of LIF neurons 306 and toggle latches 310.

In some aspects, the transition cost values computation engine 302 may be configured to output input signals 304 to the LIF neurons 306. In some implementations, the transition cost values computation engine 302 may process the violation indication information to generate the input signals 304. The input signals 304 may represent processed information related to the SAT problem, such as make and break values for variables or other relevant metrics.

In some aspects, the LIF neurons 306 may receive the input signals 304 from the transition cost values computation engine 302 and perform computations based on internal dynamics of the LIF neurons 306. The LIF neurons 306 may be implemented as a series of analog circuit elements, such as capacitors, resistors, and comparator. As an example, the LIF neurons 306 may be analog circuit elements that implement leaky integrate-and-fire neuron dynamics. In some implementations, the capacitor of the LIF neurons 306 integrates input current, while the resistor provides a leakage path, causing the integrated voltage to decay over time when no input is present. The analog nature of the LIF neurons 306 may allow for efficient parallel processing of multiple variable interactions, potentially improving the ability of the accelerator 300 to explore complex solution spaces.

In some implementations, a membrane potential of the LIF neuron 306 may represent a dynamic internal state that may evolve over time. The membrane potential may represent the neuron level of excitation or readiness to fire, which for SAT problem solving, may correspond to the likelihood of flipping the associated variable.

In some aspects, the membrane potential of the LIF neuron 306 may increase when the LIF neuron 306 receives input signals 304 indicating that flipping its corresponding variable may improve the SAT solution. The membrane potential of the LIF neuron 306 may gradually decay over time, corresponding to the leaky behavior of biological neurons.

When the membrane potential of the LIF neuron 306 reaches a certain threshold, the LIF neuron 306 may fire, potentially triggering a variable flip in the SAT problem. After firing, the membrane potential of the LIF neuron 306 may reset to a lower value, implementing a refractory period during which the LIF neuron 306 is less likely to fire again immediately.

The transformation of the membrane potential of the LIF neuron 306 over time may create a natural novelty. Variables that have not been flipped recently may be associated with the LIF neuron 306 having higher membrane potentials, making such variables more likely to be selected for next flipping. Conversely, recently flipped variables may be associated with the LIF neurons 306 having lower membrane potentials, reducing the likelihood of immediate re-selection of such variables.

This behavior of the membrane potential in the LIF neurons 306 may allow to balance exploitation of promising variable flips and exploration of the solution space. In some implementations, the membrane potential in the LIF neurons 306 may provide a form of adaptive memory to the SAT solving process, potentially improving ability of the accelerator 300 to escape local optima and find satisfying assignments more efficiently. In some implementations, the membrane potentials of the LIF neurons 306 may collectively represent a distributed, dynamic scoring system for variable selection in the SAT problem.

In operation, each LIF neuron 306 may receive an input current proportional to the make value of its associated variable. In some implementations, this current charges the capacitor, increasing the LIF neuron 306 internal voltage state. When the voltage reaches a predefined threshold, the neuron may "fire," generating a spike output and resetting its internal voltage to a baseline level. The leakage mechanism may allow the voltage of the LIF neuron 306 to decay if the LIF neuron 306 does not receive sufficiently consistent input to implement a form of temporal integration. This behavior may allow the LIF neurons 306 to naturally implement a novelty-based heuristic, where variables that relatively consistently have high make values 212 are more likely to fire and be selected for flipping, while also preventing rapid oscillation between states by introducing a refractory period after firing.

In some cases, the membrane potentials of the LIF neurons 306 may be configured to be associated with novelty values for variables in the SAT problem without requiring additional digital circuitry, memory, or external clock signals. The novelty values associated with the membrane potentials of the LIF neurons 306 may be represented as analog quantities within the LIF circuitry 214. In some aspects, the novelty values may include analog voltage levels within the LIF neurons 306. The voltage level for each neuron may correspond to the degree of novelty for its associated variable. In some implementations, the novelty values may be represented by current levels within the LIF neurons 306. The magnitude of current flow through each neuron may indicate the novelty of the corresponding variable.

In some cases, the novelty values may be associated with the membrane potential of the LIF neuron 306. As an example, the membrane potential of the LIF neuron may be associated with creating a score that can be interpreted as a novelty value. For unflipped variables, the neuron potential may increase over time, which makes it more likely for the unflipped variable to be flipped. This case may be associated with an increasing novelty value, such that it becomes more likely to flip variables that have not been flipped recently. When a variable is flipped, the membrane potential of the LIF neuron 306 is reset, such that, immediately after flipping this variable, it is the least likely for this variable to be flipped. This case may be associated with a minimal novelty value.

The novelty values may be based on various factors. In some cases, the novelty values may be based on a recency factor. The recency factor may be determined based on when each variable was last flipped. The LIF neurons 306 may track the novelty value from the previous iteration, which may be, for example, an accumulation of all previous iterations.

The novelty values may incorporate an impact factor in some implementations. The impact factor may be based on how flipping each variable affects the number of satisfied clauses. The LIF neurons 306 may evaluate the change in satisfied clauses resulting from each variable flip and factor this into processing of the novelty values.

In some cases, the novelty values may include a conflict factor. The conflict factor may be determined based on how often each variable is included in unsatisfied clauses. The LIF neurons 306 may track the occurrence of variables in violated clauses and use this information to adjust novelty values.

The LIF neurons 306 may operate in a continuous-time manner, allowing parallelized dynamics and potentially offering advantages such as simpler circuit design and increased processing throughput.

Other neuron models that exhibit dynamics similar to the LIF neurons 306 may be used by the accelerator 300. For example, the Izhikevich neuron model or the adaptive exponential integrate-and-fire model may be implemented. The alternative neuron models may offer different trade-offs between computational complexity and biological realism, potentially leading to improved performance or energy efficiency in certain scenarios.

The LIF neurons 306 may exhibit the following properties: adjustable leak rate; multi-level thresholding; hybrid analog-digital implementation; stochastic resonance integration; adaptive noise injection; temperature-based annealing; parallel problem decomposition; dynamic variable ordering; and integration with classical preprocessing.

In some implementations, the leak rate of the LIF neurons 306 may be configured to be adjustable, allowing for dynamic tuning of the novelty heuristic. By varying the leak rate, the accelerator 300 may adapt to different types of SAT problems, potentially improving convergence speed. This may be implemented through a programmable resistor in the LIF circuitry 214 or through digital control of an analog parameter, e.g., conductance of the leakage path in the LIF circuitry 214. In some implementations, the conductance may be implemented using a resistor or a transistor operating in the linear region.

Instead of using a single threshold for the LIF neurons 306, a multi-level thresholding scheme may be implemented. This approach may allow for more nuanced decision-making when selecting variables to flip. For example, the LIF neuron 306 may have different firing behaviors based on whether the LIF neuron 306 crosses a low, medium, or high threshold, potentially leading to relatively advanced novelty heuristics.

Certain components of the accelerator 300 may be implemented digitally to improve precision and/or flexibility. For instance, the make/break value computation may be performed digitally, with the results converted to analog currents for the LIF neurons 306 to process the results further. This hybrid approach may combine the energy efficiency of analog computation with the precision of digital circuits where it may be appropriate.

The inherent noise in analog circuits may be used through the principle of stochastic resonance. By tuning the noise levels in the LIF neurons 306, the ability of the accelerator 300 to escape local optima may improve. This approach may involve intentionally introducing controlled noise sources or amplifying existing thermal noise in the LIF circuitry 214.

Using the inherent noise of the accelerator 300, an adaptive noise injection may be implemented. The level of noise added to the make/break values may be dynamically adjusted based on the accelerator 300 progress solving the SAT problem. For example, noise levels may be increased when the accelerator 300 appears to be caught in a local optimum, and decreased as the solution converges.

Inspired by simulated annealing techniques, a temperature parameter could be introduced to the accelerator 300. This parameter may influence the likelihood of flipping variables with lower make/break values. The temperature may be gradually decreased over time, allowing for more exploration in the early stages of problem-solving and more exploitation in later stages.

For large SAT problems, the accelerator 300 may be extended to support parallel problem decomposition. Multiple accelerator 300 units may work on different subsets of the SAT problem relatively simultaneously sharing information between the accelerator 300 units. This approach may potentially improve scalability and solve larger problems more efficiently.

The order in which variables are processed by the accelerator 300 may be configured as dynamic and adaptive. Based on the SAT problem structure or the accelerator 300 to solve the SAT problem, the accelerator 300 may prioritize certain variables or groups of variables. This approach may be implemented through a variable reordering mechanism in the CAM circuit 202 and/or by dynamically adjusting the input currents to the LIF neurons 306.

The accelerator 300 may be integrated with classical SAT preprocessing techniques. A digital preprocessing stage may simplify the SAT problem before the SAT problem is mapped to the analog accelerator 300. This approach may involve techniques such as variable elimination, clause learning, or symmetry breaking, potentially reducing the complexity of the SAT problem tackled by the analog components.

The output of the LIF neurons 306 may be transmitted through output signals 308 to the toggle latches 310. The toggle latches 310 may store the current state of the variables being optimized. In some cases, the toggle latches 310 may be implemented as multiple latches 310A, 310B, and 310N, i.e., there may be multiple toggle latches 310 arranged in the array of N toggle latches to accommodate various SAT problem sizes and complexities. In some implementations, N variables x1, x2, ..., xN may correspond to the number of variables in the SAT problem.

In some implementations, the toggle latches 310 may capture the current state of the variables being optimized in the SAT problem. Each toggle latch 310 may correspond to a binary variable in the formulation of the SAT problem.

When the LIF neuron 306 associated with a particular variable "fires" (i.e., its internal state exceeds the threshold), the LIF neuron 306 sends a pulse through the output signals 308 to the corresponding toggle latch 310. This pulse causes the toggle latch to flip its state, effectively inverting the value of the associated variable.

The toggle latches 310 may be implemented as bistable circuits (i.e., electronic circuits that have two stable states), such as set-reset (SR) latches or Jack-Kilby (JK) flip-flops configured in toggle mode. The toggle latches 310 may be configured to operate with low-power consumption and relatively fast switching times.

In some implementations, the toggle latches 310 may operate asynchronously. The toggle latches 310 may change state when they receive a pulse from their associated LIF neuron 306, substantially regardless of any global clock signal. This asynchronous behavior allows the continuous-time operation of the accelerator 300.

The current states stored in the toggle latches 310 may be fed back to the transition cost values computation engine 302 through feedback signals 312. This feedback loop allows the accelerator 300 to update computations performed by the transition cost values computation engine 302 based on the current variable assignments, allowing iterative refinement of the SAT solution.

The LIF neurons 306 may determine when it is appropriate for a variable to be flipped based on the internal dynamics of the LIF neurons 306 and/or input signals, while the toggle latches 310 capture and flip the variable states.

In some implementations, the feedback loop is implemented through feedback signals 312. The feedback signals 312 may provide a path from the toggle latches 310 back to the transition cost values computation engine 302. This feedback mechanism may allow the accelerator 300 to iteratively refine its solutions based on previous computations, potentially improving the convergence rate and solution quality for complex SAT problems.

The accelerator 300 may operate by receiving feedback signals 312, processing them in the transition cost values computation engine 302, and then passing the results through the LIF neurons 306. The output may then be captured in the toggle latches 310, and the feedback signals 312 may return this information to the transition cost values computation engine 302 for further processing. This cycle may continue until an optimal solution is found or a stopping criterion is met.

In some aspects, the continuous-time implementation of the LIF neurons 306 may allow for asynchronous updates of variable states, potentially leading to faster convergence compared to traditional discrete-time approaches. The analog nature of the LIF neurons 306 may also enable the accelerator 300 to naturally implement stochastic optimization processes, which may be advantageous in escaping local optima and exploring the solution space more effectively.

In some implementations, the accelerator 300 may provide integrated processing and storage; non-von Neumann architecture; analog signal processing; integration of the CAM circuit 202; implementation of the LIF neurons 306; scalable configuration; energy efficiency; parallel processing; and/or adaptive problem solving.

As an example, the accelerator 300 may combine memory elements with analog computing capabilities. In some implementations, the accelerator 300 performs computations directly within the memory array. In some implementations, the accelerator 300 eliminates or reduces the traditional separation between processing and memory units. In some implementations, the accelerator 300 reduces data movement, which may be a relatively significant bottleneck in conventional computing.

In some implementations, the accelerator 300 uses relatively continuous voltage or current levels to represent and/or manipulate data. In some implementations, the accelerator 300 allows efficient implementation of operations such as vector-matrix multiplication.

In some implementations, the accelerator 300 reduces power consumption by minimizing data movement. In some implementations, the accelerator 300 uses low-power analog operations for computations.

Because the accelerator 300 includes CAM structures for relatively rapid parallel search operations, the accelerator 300 may accelerate solving SAT problems through parallelism. As an example, the accelerator 300 may efficiently evaluate SAT clauses and variable assignments. This may allow the accelerator 300 to address a wide range of problem sizes and complexities.

In some implementations, the accelerator 300 dynamically adjusts to SAT problem characteristics through analog dynamics. As an example, in some implementations, the accelerator 300 might implement novelty-based heuristics without explicit digital logic.

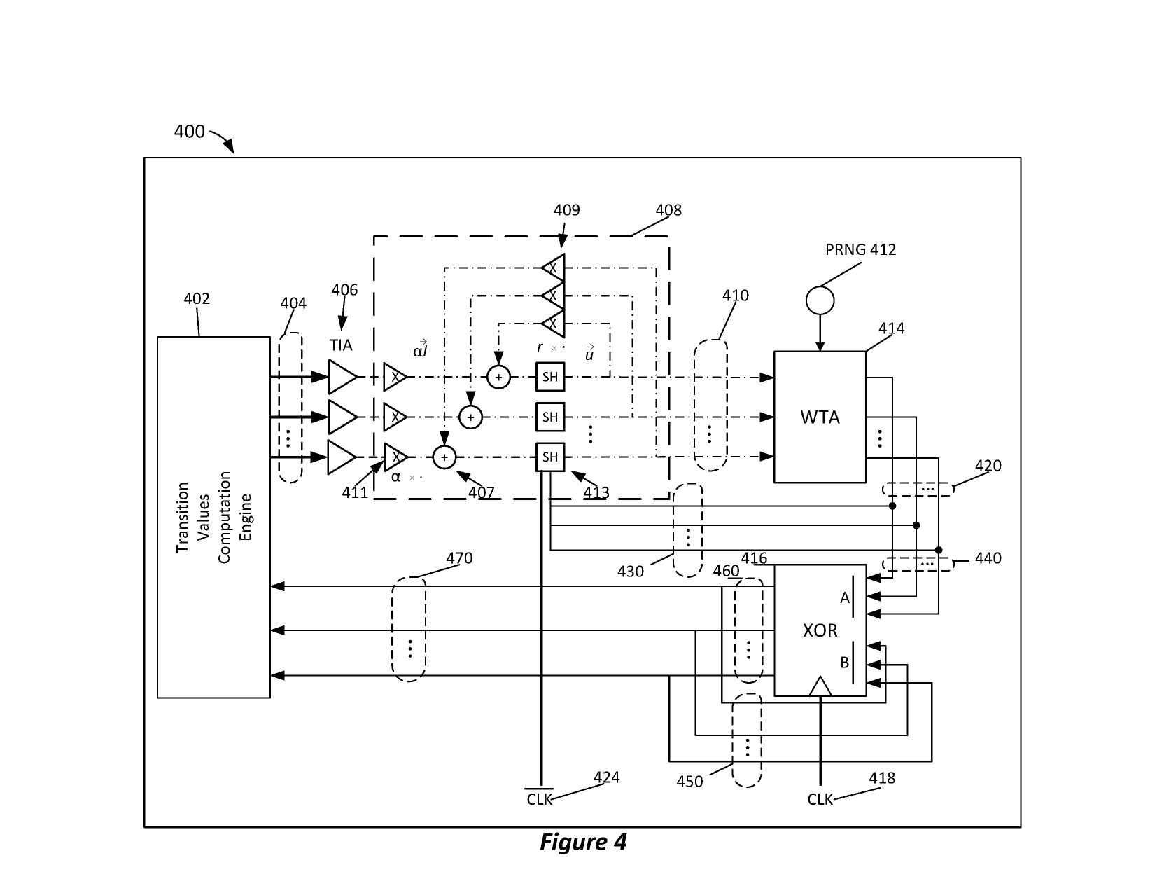

FIG. 4 illustrates an example accelerator 400 for solving discrete optimization problems, according to some implementations. The accelerator 400 may include an optimization preprocessing circuit and an LIF engine 408, which may be configured to perform exponential moving average (EMA) computation. In some implementations, the accelerator 400 may include a WTA 414 and an XOR gate 416 (or an exclusive OR gate).

In some implementations, the LIF engine 408 may implement a plurality of LIF neurons 306. In some aspects, the membrane potentials of the LIF neurons 306 may be configured to be associated with novelty values for variables in the SAT problem.

In some implementations, the optimization preprocessing circuit may analyze clause violations in a SAT problem and generate the transition cost values for decisions involving flipping the variables. In some implementations, the optimization preprocessing circuit may be a transition cost values computation engine 402.

In some implementations, the transition cost values computation engine 402 may be configured to provide input currents to the LIF engine 408. The accelerator 400 may process violation indication information in the transition cost values computation engine 402. As an example, the transition cost values computation engine 402 may process the violation indication information and provide the output based on the violation indication information as input signals 404 to the subsequent stages of the accelerator 400.

In some implementations, the violation indication information may be represented by analog voltage or current levels, where the magnitude of the analog voltage or current levels may represent the degree of violation for each clause; this approach may be potentially suitable for an analog domain. In some implementations, the violation indication information may be represented by a binary string, where each bit represents the satisfaction state of a corresponding clause; this approach may be potentially suitable for a digital domain.

In some implementations, the violation indication information may be represented by a list of unsatisfied literals within each violated clause, which may provide more detailed information for relatively complex optimization algorithms. In some implementations, the violation indication information may be represented by floating-point values indicating the degree of satisfaction or violation for each clause; such technique may allow relatively continuous relaxation approaches to SAT solving. In some implementations, the violation indication information may be represented by time-domain signals.

In some aspects, the transition cost values computation engine 402 may output the input signals 404, which may be received by transimpedance amplifiers (TIAs) 406. The LIF engine 408 may in turn receive signals from the TIAs 406. As an example, the updated make values 212 may be provided as input currents to the LIF engine 408 through the transimpedance amplifiers (TIAs) 406.

In some implementations, the transition cost values computation engine 402 may be used to implement a discrete-time version of the leaky LIF neuron dynamics. In some implementations, the LIF engine 408 may be used for generating novelty-related information in the SAT solving process. This approach may correspond to the behavior of LIF neurons in a discrete-time setting, potentially allowing for the implementation of novelty-based heuristics without requiring continuous-time analog circuits.

The EMA computation performed by the LIF engine 408 may be a type of moving average that allows the accelerator 400 be more responsive to new information compared to a typical moving average. In some implementations, EMA may be used to track and update variable states and/or scores over time. As an example, the EMA may calculate scores, which may be used to determine which variables are most promising to flip in each iteration of the optimization process.

The EMA computation may be used to process the make and break values for variables in the SAT problem; update internal states of the discrete-time equivalent of LIF neurons; implement a form of memory that allows implementation of novelty-based heuristics in a clocked, discrete-time manner.

In some cases, the transition cost values computation engine 402 and the LIF engine 408 may work in conjunction with other components such as the WTA circuit 414 and the XOR gate 416 to implement a discrete-time approximation of the continuous-time SAT solver dynamics.

In some cases, the LIF engine 408 may include multiple processing elements, such as adders 407, multipliers 409 and 411, and sample-and-hold (SH) cells 413. These components may work together to implement the functionality of the LIF neurons of the LIF engine 408. In some implementations, the LIF engine 408 may implement the LIF neuron model using these components to calculate a score for each variable in the optimization problem.

The LIF engine 408 may perform EMA computation in the analog domain. As used herein, the phrase “analog domain” may refer to a domain of signal processing and computation where information is represented by relatively continuously variable physical quantities, such as voltage, current, or charge. In the analog domain, values can take on various levels within a given range, as opposed to discrete levels in the digital domain.

When a quantity is represented over continuous time, it may be denoted by a function of time, such as f(t). The function f(t) may describe how the quantity changes as time progresses, with t being measured in, e.g., seconds. When a quantity is represented over discrete time, it may be denoted by a sequence of values, such as f_0, f_1, f_2, ..., where each value corresponds to a specific iteration or flip. In some implementations, when a certain representation that is specific to a particular variable is made, such representation may be denoted by f_i, where i may correspond to a specific variable, such as x_i.

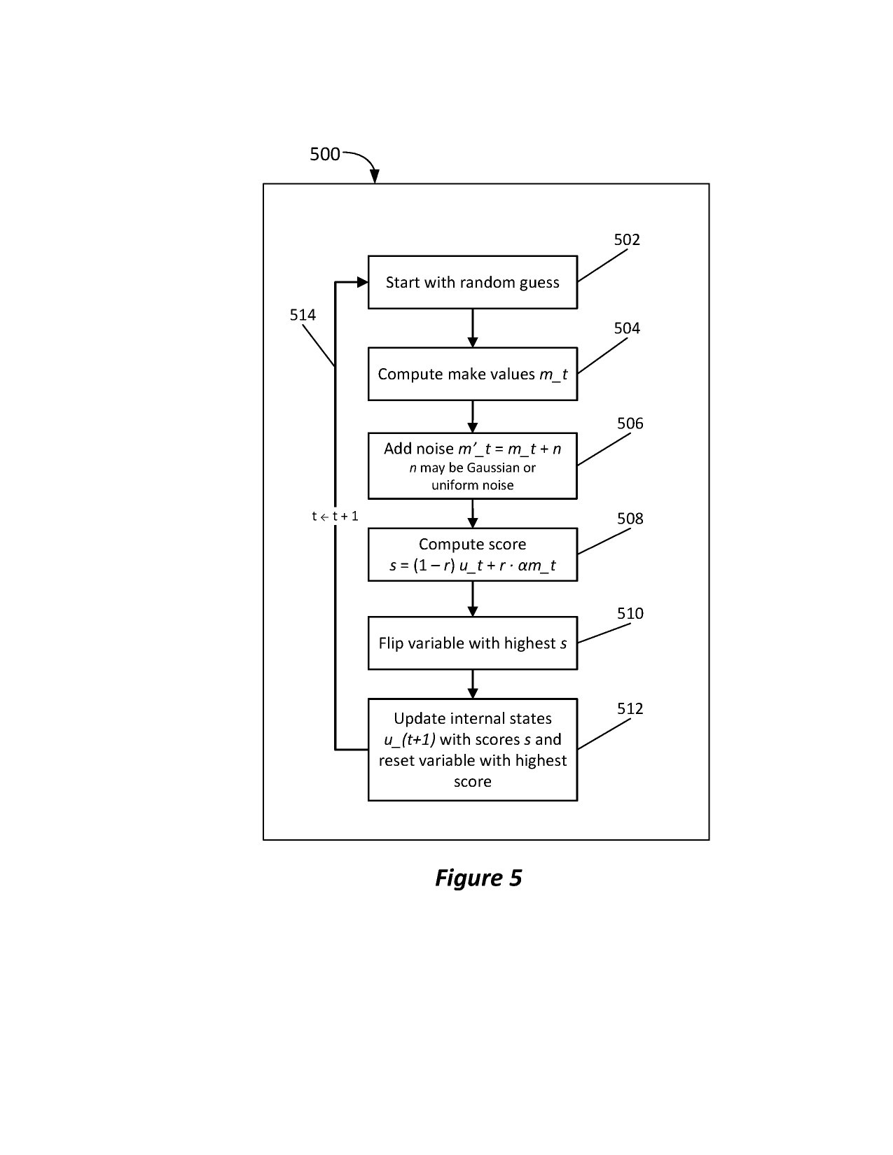

In some implementations, the score s for a particular variable at time t may determine how likely the variable is to be flipped. The score s calculation may be performed using the following score function s = (1 - r) × u_t + r × α × m'_t, where s is the score for a particular variable; r is a hyperparameter having a value between 0 and 1 (i.e., 0 < r < 1); u_t is the internal state of the neuron at time t; and m'_t is the noise-perturbed make value at time t; and α is another hyperparameter. See also, FIG. 5. In some implementations, the make values 212 may be computed and processed in real-time or near real-time using various circuits of the accelerator 400.

The hyperparameter r may control the balance between the internal state of the LIF neuron of the LIF engine 408 and the current make value in the score calculation. The hyperparameter r may control the balance between these two components: e.g., when r is close to zero (0), the score relies more on the neuron internal state; when r is close to one (1), the score relies more on the current make value, the break value, or combination of the make and break values (e.g., gain, which is the difference between the make and break values).

The internal state u_t of the LIF neuron of the LIF engine 408 at time t represents the accumulated "charge" or "potential" of the LIF neuron of the LIF engine 408. A hyperparameter α may scale the impact of the noise-perturbed make values (m'_t) on the overall score s. The noise-perturbed make value m'_t at time t may represent how many currently unsatisfied clauses may become satisfied if this variable were flipped, m'_t may be noise-perturbed to a suitable range. The score function may incorporate the internal state (u_t) of the LIF neuron of the LIF engine 408 with the noise-perturbed make value (m'_t).

Updating the internal state of the LIF neuron of the LIF engine 408may be performed using the following equation u_(t+1) = (1 - r) × u_t + r × I_t, where u_(t+1) is the updated internal state for the next time step; u_t is the current internal state; and r is the hyperparameter in the score calculation; I_t is the input current at time t. The hyperparameter r may control the balance between retaining the current state and incorporating a new input.

The input current I_t may be calculated according to the following equation I_i(t) = α × (make value of x_i), where α is the hyperparameter as in the score calculation; x_i is the binary variable associated with the LIF i-th neuron in the SAT problem; and the make value of x_i is a raw make value for variable x_i. The raw make value for variable x_i may represent how many unsatisfied clauses may become satisfied if x_i were flipped. In some implementations, the hyperparameter α scales the make value to an appropriate current level. Calculation for updating the internal state of the LIF neuron of the LIF engine 408 may implement leaky integration of the input current. The term (1 - r) × u_t may represent the leak, while r × I_t may represent the integration of new input.

Although the use of I_t current is described herein, voltage signals can also be used in the LIF engine 408, according to some implementations. As an example, the accelerators 300 and 400 may use voltage signals. In some implementations, the hyperparameter α can be used to modulate the make value, break value, or combination value computed by the LIF circuitry 214 in accelerator 300 or the LIF engine 408 in the accelerator 400.

In some implementations, the threshold and variable flipping may be implemented in the following manner. If u_i(t) exceeds a threshold voltage Vth, then u_i(t) may be set to zero (0) (i.e., the u_i(t) state is reset) and x_i is flipped (i.e., the value of x_i is inverted), i.e., when the internal state the LIF neuron of the LIF engine 408 exceeds the voltage threshold Vth, the LIF neuron of the LIF engine 408 "fires." This implements the "fire" part of the leaky integrate-and-fire model. When the neuron "fires", it triggers resetting the internal state of the LIF neuron of the LIF engine 408 and to change the variable associated with that LIF neuron of the LIF engine 408.

In some implementations, representation of a membrane potential in the LIF neuron of the engine 408 may be the internal state u_i(t) for each variable x_i in the SAT problem. The transformation of the representation of the membrane potential may be described by the equation u_(t+1) = (1 - r) × u_t + r × I_t, where u_i(t) may represent the membrane potential at time t; r represents a decay factor (a value of r may be between zero (0) and one (1)); and I_i(t) may be the input current, which may be proportional to the make value of variable x_i.

The representation of the membrane potential as the internal state u_i(t) may increase when the LIF neuron of the LIF engine 408 receives an input (e.g., a positive current I_i(t)) and decay over time due to the leakage factor, e.g., expressed by (1 - r). When the internal state u_i(t) exceeds a threshold Vth, as may be evaluated in the WTA circuit 414, the LIF neuron of the LIF engine 408 may fire, potentially triggering a variable flip in the SAT problem.

The LIF engine 408 may implement the above functions using analog circuits. As an example, within the LIF engine 408, several components may temporarily hold or process make values 212. In some implementations, the multipliers 411 may multiply the input signals (which correspond to make values 212) by a scaling factor α. The hyperparameters r and α may be implemented as programmable analog values, allowing to tune the behavior of the accelerator 400. In some implementations, the hyperparameters r and α may be implemented using, for example, operational amplifiers with controllable gain.

In some implementations, the adders 407 may combine the scaled make values 212 with other signals as part of the score computation or internal state update. The sample-and-hold (SH) cells 413 may be used to capture and maintain the novelty values. In some implementations, SH cells 413 may temporarily store the results of computations involving make values 212, effectively holding this information for a short period. In some implementations, the SH cells 413 may reset functions for the novelty values. As an example, the SH cells, where the capacitor holding the charge will be discharged by a reset switch

The adders 407 and multipliers 409 and 411 may be used to implement the exponential decay. The WTA circuit 414 may evaluate the novelty values together with other factors to determine which variables to flip in each iteration of the optimization process.

In some implementations, the transition cost values computation engine 402 may process the make values 212 as part of computing transition cost values or other metrics used in the optimization process. In some implementations, the make/break values may be represented as analog current or voltage levels, which may be relatively continuously processed and updated.

Calculation of the score s may be implemented using multipliers 409 and 411 for the terms (1 - r) × u_t and r × α × m'_t; the adder 407 may be used to sum these terms. Updating of the internal state of the LIF neuron of the LIF engine 408 may be implemented using multipliers 409 and 411 for the terms (1 - r) × u_t and r × I_t; the adder 407 to sum these terms; the SH cell 413 may be used to capture the updated state.

The threshold comparison and variable flipping may be implemented using a comparator to check if u_i(t) exceeds Vth. A flip-flop or similar circuit may be used to invert the variable value when the Vth threshold is exceeded.

In some implementations, the accelerator 400 may operate in discrete time, where the internal states of all LIF neurons of the LIF engine 408 are updated synchronously at fixed time intervals. The use of sample-and-hold circuits and clocked comparators may allow relatively precise control over the timing of score computations and state updates. This discrete-time approach may offer advantages in terms of deterministic behavior and easier integration with digital control logic, while still maintaining efficiency in parallel variable processing compared to purely digital implementations.

The LIF engine 408 may output signals 410, which may be received by a WTA circuit 414. In some cases, the WTA circuit 414 may receive extrinsic noise such as pseudo-random noise from a pseudo-random number generator (PRNG) 412. In some implementations, the extrinsic noise may include an injected noise such as power supply fluctuations and/or external electromagnetic interference.

However, in some aspects, the LIF neurons may be configured to use intrinsic circuit noise as a source of randomness, potentially allowing the computing system to operate without a dedicated PRNG or other sources of extrinsic noise. In some implementations, the PRNG noise may be injected in other components of the accelerator 400, e.g., during, before, and/or after the TIAs 406.

The WTA circuit 414 may send signals 440 to the XOR gate 416. The XOR gate may be a digital logic gate to perform the exclusive disjunction operation. The accelerator 400 may include clock inputs: e.g., clock input 418 coupled to the XOR gate 416 and clock input 424 coupled to the LIF engine 408. These clock inputs may synchronize the operations of different components.

Multiple feedback paths may be present in the accelerator 400. Feedback signals 430 may couple the LIF engine 408 to the WTA circuit 414. Feedback signals 450 may couple the XOR gate 416 to the transition cost values computation engine 402. The XOR gate 416 may output feedback signals 470 to provide feedback from the XOR gate 416 to the transition cost values computation engine 402. The various feedback paths may allow the accelerator 400 to refine its solutions iteratively.

In operation, the transition cost values computation engine 402 may process input data and send it to the LIF engine 408 through the input signals 404 and transimpedance amplifiers 406. The LIF engine 408 may perform computations on this data, implementing the dynamics of the LIF neurons of the LIF engine 408. The WTA circuit 414, potentially influenced by intrinsic circuit noise or extrinsic noise such as the PRNG 412, may select the best result. The XOR gate 416 may combine this result with the feedback signals 450 to generate the final output.

In the accelerator 400, toggle latches may be implemented as part of the output stage or as an interface between the LIF engine 408 and other components. The toggle latches may serve a similar function to the toggle latches 310 shown in FIG. 3.

The toggle latches may be coupled after the WTA circuit 414. In this configuration, the output signals 410 from the LIF engine 408 may pass through the WTA circuit 414, which selects the most promising variable to flip. The output of the WTA circuit 414 may then be fed into a set of toggle latches.

Each toggle latch may correspond to a variable in the SAT problem. When a neuron in the LIF engine 408 fires and its corresponding variable is selected by the WTA circuit 414, the appropriate toggle latch may be triggered to flip a state of that SAT variable. The toggle latches may capture the current state (e.g., zero (0) or one (1)) of each variable in the SAT problem. When a toggle latch is triggered, it may invert its current state, "flipping" the variable that the toggle latch represents.

The outputs of the toggle latches may then be fed back to the transition cost values computation engine 402 via feedback signals similar to the feedback signals 470 shown in FIG. 4. This feedback loop may allow the accelerator 400 to update the input signals received by the transition cost values computation engine 402 based on the newly flipped variable and continue the optimization process.

While the optimization preprocessing circuit, and more specifically, the transition cost values computation engine 402, is described as an analog in-memory circuit, in some cases other implementations involving non-analog circuits may be used to perform similar functionality. These alternative implementations may include digital logic circuits, memory-based lookup systems, a field-programmable gate array (FPGA), software-based preprocessing modules, and/or hybrid digital-analog approaches.

In some implementations, the CAM and/or DPE functionality of the transition cost values computation engine 402 may be implemented using digital logic circuits. This approach may use digital comparators to evaluate clause satisfaction, adders and multipliers to calculate make and break values, and/or registers to store intermediate results.

In some implementations, instead of or in addition to performing real-time or near real-time computations, the accelerator 400 may use pre-computed lookup tables stored in digital memory. This approach may involve using input variables as addresses to access pre-calculated clause satisfaction states, retrieving pre-computed make and break values from memory, and/or potentially combining multiple memory accesses for more complex problems.

In some implementations, the CAM and DPE functionality of the transition cost values computation engine 402 may be implemented on FPGA. This approach may offer relative flexibility and reconfigurability, allowing custom digital logic designs for clause evaluation and cost calculation and/or relatively straightforward updates to the algorithm or the SAT problem structure.

In some implementations, some or all of the CAM and DPE functionality of the transition cost values computation engine 402 may be performed by software running on a general-purpose processor. In this scenario the software may preprocess the SAT problem structure, the hardware accelerator may focus on the core optimization loop, and/or the transition cost values computation engine 402 may interpret the preprocessed data.

In some implementations, hybrid digital-analog approach may be used when, e.g., digital circuits may handle clause evaluation and basic computations while analog components may be used only for specific operations where they offer relatively significant advantages.

FIG. 5 illustrates an example method 500 for solving discrete optimization problems, according to some implementations. The method 500 may use the LIF model for solving SAT optimization problems. The method 500 may begin with step 502, where a random guess may be made as a starting point for the optimization process. Step 502 may be performed by the SAT optimizer 128 in FIG. 1 or initialized in the toggle latches 310 in FIG. 3. This initial configuration may serve as a basis for subsequent iterations and refinements.

In step 504, the make values m_t may be computed based on the current configuration. The make values 212 (or break values or combinations of make and break values) may represent the potential improvement in the optimization objective if a particular variable is flipped or changed. In some aspects, the computation of make values 212 may be performed using a DPE or other suitable hardware components within the accelerator 110, 200, 260, 300, 400. As an example, step 504 may be performed by the DPE 204 in FIG. 2A, which outputs make values 212. Step 504 may be performed the transition cost values computation engine 402 in FIG. 4.

Step 506 may involve adding noise to the make values 212. The noise n may be either Gaussian or uniform and it may be represented by the equation m’_t = m_t + n. The addition of noise may introduce stochasticity into the optimization process, potentially allowing the accelerator 110, 200, 260, 300, 400 to escape local optima and explore the solution space more effectively. In some cases, the noise may be generated using a pseudo-random number generator 412 (e.g., in the accelerator 400), while in other aspects, the accelerator 110, 200, 260, 300, 400 may exploit intrinsic circuit noise to eliminate or reduce the need for extrinsic noise such as dedicated random number generation circuitry. As an example, the pseudo-random number generator (PRNG) 412 in FIG. 4 may provide the extrinsic noise input. The addition of noise may occur within the LIF circuitry 214, the CAM circuit 202 and DPE 204 in FIG. 2A and/or the transition cost values computation engine 302 shown in FIG. 3, which may perform functions analogous to those carried out by the CAM circuit 202 and DPE 204.

The method 500 may then proceed to step 508 to compute score s. The score s may be calculated using the equation s = (1 - r) × u_t + r × α × m_t, where u_t represents the internal states of the LIF neurons, and α × m_t is a processed version of the make values 212. In some implementations, the internal state u_t may represent the membrane potential, and m_t may be the make value. This scoring technique may incorporate both the current state of the LIF neurons of the LIF engine 408 and the potential improvements indicated by the make values 212, allowing for a balanced approach to variable selection. In some implementations, step 508 may be performed within the LIF engine 408 in FIG. 4, using the adders 407, multipliers 409 and 411, and sample-and-hold cells 413.

In step 510, the variable with the highest score s may be flipped. This step may represent the decision-making process in the optimization algorithm, where the most promising change is made based on the computed scores s for variables. The flipping of variables may be implemented using toggle latches 310 or other suitable hardware components within the accelerator 110, 200, 260, 300, 400. As an example, step 510 may be performed in concert by the LIF neurons 306 (FIG. 3) sending a signal through output signals 308 to flip the state in toggle latches 310. In FIG. 4, this may involve the winner-take-all circuit 414 and the XOR gate 416.

Step 512 may involve updating the internal states u_t of the LIF neurons of the LIF engine 408. In some implementations, this update may be made using the computed scores s, and the highest score may reset the corresponding variable. Step 512 may correspond to the behavior of the LIF neurons 306 or neurons of the LIF engine 408, where their internal states are updated based on inputs and then reset after firing. As an example, after firing, the membrane potential of the LIF neuron 306 or the representation of the membrane potential of neuron of the LIF engine 408 may be reset, such that the internal states (corresponding to the membrane potentials or their representation) of the LIF neurons may be updated and the variable corresponding to the highest score s may be reset.

In some implementations, step 512 may be performed by the LIF engine 408 in FIG. 4, particularly using the sample-and-hold cells 413. The updating of internal states may allow the accelerator 110, 200, 260, 300, 400 to maintain a memory of recent changes and influence future decisions.

In step 514, a feedback loop is performed, incrementing the time step (represented by assignment t ← t + 1, i.e., taking the current value of t, adding 1 to it, and assigning this new value back to t) and returning to step 504. The feedback loop may represent the iterative nature of the optimization process, where the algorithm continues to refine the solution over multiple time steps. The feedback mechanism may allow the accelerator 110, 200, 260, 300, 400 to adapt its behavior based on previous results and potentially converge towards an optimal solution. Step 514 may correspond to the feedback signals 312 transmitted from toggle latches 310 to the transition cost values computation engine 302 and/or the feedback signals 470 from the XOR gate 416 to the transition cost values computation engine 402.

The method 500 may combine elements of stochastic optimization with the dynamics of LIF neurons 306, potentially offering a novel approach to solving complex SAT optimization problems. The inclusion of noise and the use of internal states in the scoring process may allow the algorithm escape local optima and explore the solution space more effectively. In some aspects, the continuous-time implementation of the LIF neurons 306 may allow for asynchronous updates of variable states, potentially leading to faster convergence compared to traditional discrete-time approaches.

In some cases, the accelerator 110, 200, 260, 300, 400 may implement an annealing schedule by dynamically adjusting parameters of the LIF neurons 306. For example, the threshold voltage or leak rate of the LIF neurons 306 or neurons of the LIF engine 408 may be modified over time. This dynamic adjustment may allow balancing exploration and exploitation during the optimization process, potentially improving the ability of the accelerator 110, 200, 260, 300, 400 to find global optima in relatively complex solution spaces.

The accelerator 110, 200, 260, 300, 400 may be extended to handle multi-objective optimization problems. In some aspects, this may be achieved by using multiple DPE arrays and/or multiple sets of LIF neurons 306, each corresponding to a different objective function. The system may process these multiple objectives in parallel, potentially enabling efficient exploration of trade-offs between competing goals.

The versatility of the accelerator 110, 200, 260, 300, 400 in handling various optimization problems may make it suitable for applications in diverse fields such as machine learning, quantum computing simulation, and complex system design. By leveraging the same core hardware components for different problem types, the accelerator 110, 200, 260, 300, 400 may offer a flexible and efficient solution for a wide range of computational challenges.

The method 500 using accelerator 110, 200, 260, 300, 400 may provide several advantages for solving complex optimization problems such as SAT problem. In some implementations, using analog circuit dynamics and in-memory computation, the method 500 may offer improved energy efficiency and processing speed compared to traditional digital implementations.

Although FIG. 5 shows example blocks of the method 500, in some implementations, the method 500 may include additional blocks, fewer blocks, different blocks, or differently arranged blocks than those depicted in FIG. 5. Additionally, or alternatively, two or more of the blocks of method 500 may be performed in parallel.

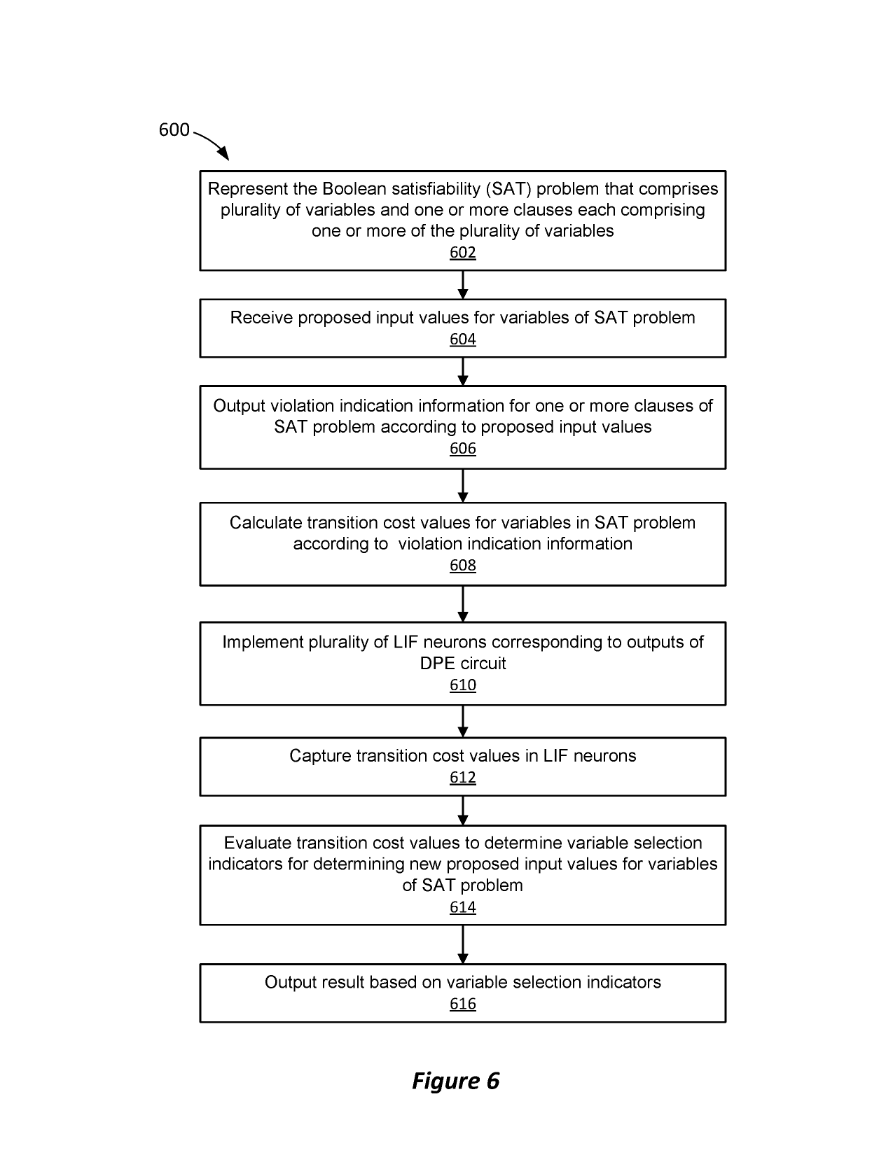

FIG. 6 illustrates an example method 600 for solving discrete optimization problems, according to some implementations. The method 600 may use the LIF neurons 306 of neurons of the LIF engine 408 for solving SAT optimization problems. The method 600 begins with step 602, where the SAT problem is represented, including a plurality of variables and one or more clauses, each clause comprising one or more of the plurality of variables. This representation may be implemented in the CAM circuit 202 of the accelerator 200, where each row of CAM cells (222, 224, 226, 228 and 232, 234, 236, 238) may store a clause of the SAT problem. In some implementations, each DPE cell (242, 244, 246, 248 and 252, 254, 256, 258) of the DPE 204 may store a binary value indicating whether a variable is present in the corresponding clause.

The method 600 then moves to step 604, where proposed input values for variables of the SAT problem are received. These input values may correspond to the input variables 210 in FIG. 2A, which are fed into the CAM circuit 202.

Following this, in step 606, violation indication information is output for one or more clauses of the SAT problem according to the proposed input values. This step may be performed by the SAT verification circuit 118 in FIG. 1, which processes the input 112 containing the formula 114 and interpretation 116 to determine if the variables satisfy the clauses. In some implementations, the CAM circuit 202 may output the violation indication information for one or more clauses of the SAT problem according to the proposed input values.

Next step 608 involves calculating transition cost values for variables in the SAT problem according to the violation indication information. This calculation may be performed by the DPE 204 in FIG. 2A, which computes make values 212 (or break values or combination of the make and break values) based on the information received from the CAM circuit 202 via the match lines ML 1 and ML 2.

The method 600 may then proceed to step 610, where a plurality of the LIF neurons of the LIF engine 408 corresponding to outputs of a DPE 204 are implemented. This step may involve the LIF circuitry 214 in FIGS. 2A-2B or the LIF engine 408 in FIG. 4 to processing the make values 212.

In step 612, the transition cost values are captured in the LIF neurons of the LIF engine 408. This capturing of the transition cost values may occur within the LIF engine 408, potentially using the sample-and-hold cells 413 to capture the values transition cost.

The method 600 may continue with step 614, during which the transition cost values may be evaluated to determine variable selection indicators for determining new proposed input values for variables of the SAT problem. This evaluation may be performed by the LIF circuitry 214. In some implementations, this evaluation may be performed by the WTA circuit 414 in FIG. 4, which may select the most promising variable changes based on the outputs of the LIF neurons of the LIF engine 408.

In step 616, the method 600 outputs a result based on the variable selection indicators. This output may correspond to the output variables 216 in FIGS. 2A-2B or the output signals 420 in FIG. 4, which represent the updated variable assignments or potential solutions to the SAT problem. Step 616 may be performed by the LIF circuitry 214, e.g., by the toggle latches 310 in FIG. 3.

The method 600 may operate in an iterative manner, similar to the feedback loop created by the new interpretation 130 in FIG. 1. The output from step 616 may be fed back into step 604 as new proposed input values, allowing the accelerator 110, 200, 260, 300, 400 to continuously refine its solutions until a satisfactory result is found or other termination criteria are met.

The method 600 using the accelerator 110, 200, 260, 300, 400 may offer advantages in terms of energy efficiency, processing speed, and hardware complexity compared to conventional digital implementations for solving SAT and other discrete optimization problems.

Although FIG. 6 shows example blocks of the method 600, in some implementations, the method 600 may include additional blocks, fewer blocks, different blocks, or differently arranged blocks than those depicted in FIG. 6. Additionally, or alternatively, two or more of the blocks of method 600 may be performed in parallel.

A number of implementations have been described. Nevertheless, it will be understood that various modifications may be made without departing from the spirit and scope of the disclosure. Accordingly, other implementations are within the scope of the following claims.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts may operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computing system, comprising:
a content-addressable memory (CAM) circuit configured to:
represent a Boolean satisfiability (SAT) problem that comprises a plurality of variables and one or more clauses each comprising one or more of the plurality of variables;
receive proposed input values for the variables of the SAT problem; and
output violation indication information for the one or more clauses of the SAT problem according to the proposed input values;
a dot product engine (DPE) circuit coupled to the CAM circuit and configured to calculate transition cost values for the variables in the SAT problem according to the violation indication information; and
leaky integrate-and-fire (LIF) circuitry coupled to the DPE and configured to:
implement a plurality of LIF neurons corresponding to outputs of the DPE;
capture the transition cost values in the LIF neurons;
evaluate the transition cost values to determine variable selection indicators for determining new proposed input values for the variables of the SAT problem; and
output a result based on the variable selection indicators.

2. The computing system of claim 1, wherein the LIF neurons are implemented in a continuous-time manner or in a time-discrete manner.

3. The computing system of claim 1, wherein:
the CAM circuit comprises a ternary content-addressable memory (TCAM) array that comprises a plurality of rows, each row of the plurality of rows comprising a plurality of TCAM cells;
each clause of the SAT problem is programmed to a respective row of the TCAM array;
each occurring variable of each clause is mapped to a respective TCAM cell of the row; and
each non-occurring variable is programmed as a don't care value.

4. The computing system of claim 1, wherein the violation indication information comprises a binary value for each clause, indicating whether the clause is satisfied or violated by the proposed input values.

5. The computing system of claim 1, wherein the LIF circuitry is configured to use at least one of intrinsic circuit noise or extrinsic noise as a source of randomness in determining the variable selection indicators.

6. The computing system of claim 1, wherein transition cost values comprise one or more of make values or break values for variables in the SAT problem.

7. The computing system of claim 1, wherein the LIF circuitry is configured to implement a novelty-based heuristic using novelty values for determining the variable selection indicators.

8. The computing system of claim 7, wherein the novelty values are based on one or more of:
a recency factor based on when each variable was last flipped;
an impact factor based on how flipping each variable affects a number of satisfied clauses; or
a conflict factor based on how often each variable is included in unsatisfied clauses.

9. The computing system of claim 7, wherein:
the novelty values comprise one or more of analog voltage levels or analog current levels within the LIF neurons; and
the analog voltage levels or the analog current levels correspond to a degree of novelty for each variable.

10. The computing system of claim 7, wherein the novelty values correspond to at least one of a membrane potential of the LIF neuron of the plurality of LIF neurons or a representation of the membrane potential.

11. A computing system, comprising:
an optimization preprocessing circuit configured to:
represent a Boolean satisfiability (SAT) problem that comprises a plurality of variables and one or more clauses each comprising one or more of the plurality of variables;
receive proposed input values for the variables of the SAT problem;
output violation indication information for the one or more clauses of the SAT problem according to the proposed input values; and
calculate transition cost values for the variables in the SAT problem according to the violation indication information; and
leaky integrate-and-fire (LIF) circuitry configured to:
implement a plurality of LIF neurons, wherein each LIF neuron corresponds to a transition cost value of the transition cost values calculated by the optimization preprocessing circuit;
capture the transition cost values in the LIF neurons;
evaluate the transition cost values to determine variable selection indicators for determining new proposed input values for the variables of the SAT problem; and
output a result based on the variable selection indicators.

12. The computing system of claim 11, further comprising at least one of a content-addressable memory (CAM) circuit or a dot product engine (DPE).

13. The computing system of claim 11, further comprising a transition cost value computation engine configured to provide input to the LIF neurons.

14. The computing system of claim 13, wherein the transition cost value computation engine comprises a dot product engine (DPE).

15. The computing system of claim 14, wherein the LIF neurons are configured to use intrinsic circuit noise as a source of randomness.

16. A method for solving a Boolean satisfiability (SAT) problem, the method comprising:
representing the SAT problem that comprises a plurality of variables and one or more clauses each comprising one or more of the plurality of variables;
receiving proposed input values for the variables of the SAT problem;
outputting violation indication information for the one or more clauses of the SAT problem according to the proposed input values;
calculating transition cost values for the variables in the SAT problem according to the violation indication information;
implementing a plurality of LIF neurons corresponding to outputs of the DPE;
capturing the transition cost values in the LIF neurons;
evaluating the transition cost values to determine variable selection indicators for determining new proposed input values for the variables of the SAT problem; and
outputting a result based on the variable selection indicators.

17. The method of claim 16, wherein a content-addressable memory (CAM) circuit performs:
representing the SAT problem that comprises a plurality of variables and one or more clauses each comprising one or more of the plurality of variables;
receiving proposed input values for the variables of the SAT problem; and
outputting violation indication information for the one or more clauses of the SAT problem according to the proposed input values.

18. The method of claim 16, wherein a dot product engine (DPE) circuit performs calculating transition cost values for the variables in the SAT problem according to the violation indication information.

19. The method of claim 16, wherein leaky integrate-and-fire (LIF) circuitry performs:
implementing a plurality of LIF neurons corresponding to outputs of the DPE;
capturing the transition cost values in the LIF neurons;
evaluating the transition cost values to determine variable selection indicators for determining new proposed input values for the variables of the SAT problem; and
outputting a result based on the variable selection indicators.

20. The method of claim 19, wherein the LIF neurons are implemented in at least one of a continuous-time manner or a time-discrete manner.
